(19) United States
(12) Patent Application Publication
(10) Pub. No.: US 2008/0188636 A1
(43) Pub. Date: Aug. 7, 2008

(54) POLYMER DERIVATIVES AND COMPOSITES FROM THE DISSOLUTION OF LIGNOCELLULOSICS IN IONIC LIQUIDS

(75) Inventors: Dimitris Argyropoulos, Raleigh, NC (US); Haibo Xie, Raleigh, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: North Carolina State University

(21) Appl. No.: 12/026,998

(22) Filed: Feb. 6, 2008

Related U.S. Application Data
(60) Provisional application No. 60/888,447, filed on Feb. 6, 2007.

(51) Int. Cl. C08F 251/02

(52) U.S. Cl. 527/300

(57) ABSTRACT

The present invention provides wood derivatives and composite materials prepared by first solvating a lignocellulosic material using an ionic liquid. The solvated lignocellulosic material can be derivatized to incorporate functional groups, particularly groups that facilitate later combination with polymer materials, including non-polymer polymers. The polymeric materials can be combined with the derivatized lignocellulosic material in solution, or the derivatized lignocellulosic material can be isolated and later combined with the polymeric material in a melt. The invention encompasses a variety of wood derivatives, composites, and nanocomposites useful for preparing multiple types of products, including membranes, fibers, and formed parts.

### CROSS-REFERENCE TO RELATED APPLICATIONS

The present patent application claims priority to U.S. Provisional Patent Application No. 60/888,447, filed Feb. 6, 2007, which is incorporated herein by reference in its entirety.

### FIELD OF THE INVENTION

The present invention is directed to composite materials, and methods of preparation thereof. More particularly, the invention is directed to wood polymer derivatives and composite materials prepared using lignocellulosic material obtained by dissolution in ionic liquid.

### BACKGROUND

Biomass is an increasingly popular starting material for production of a variety of materials. Ever growing energy demands and environmental concerns have particularly prompted much toward work developing convenient and efficient pathways for converting biomass to biofuels, valuable chemicals, and biomaterials.

Wood is the most abundant lignocellulosic resource on the planet. Although wood has long been used as raw materials for building, fuel, and various products, its use for converting to biofuel and producing valuable chemicals and biomaterials has only recently been considered in light of development of bioengineering and catalytic chemistry.

The complex structure of wood makes it insoluble in common molecular solvents, and preliminary chemical or physical treatment is thus necessary for further applications. Such preliminary treatments, especially chemical treatment, are generally undesirable because of the use and/or release of environmentally unfriendly chemicals. For example, NaOH and NaSH typically must be used to delignify wood in the kraft pulping manufacturing technology, which is the most popular method used in the paper industry.

For the traditional conversion of wood into composite-materials, wood flour is used or heterogeneous chemical modification is performed. Performing these processes is plagued by feedstock-degradation, as well as the unavoidable consumption of large amounts of energy and expensive chemicals. The traditional method to obtain biodegradable plastic and composites is heterogeneous graft modification, which has been disclosed in U.S. Pat. No. 5,424,382, U.S. Pat. No. 5,741,875, U.S. Pat. No. 5,852,069, and U.S. Pat. No. 6,013,774. These methods suffer drawbacks such as low efficiency and utilization of hazardous chemicals. Furthermore, these processes lack the desired ability to directly convert lignocellulosic biomass to spinning fibers or membrane materials.

Lignin is a vastly under-utilized natural polymer. Commercial lignin is currently produced as a co-product of the paper industry, separated from trees by a chemical pulping process. Lignosulfonates (also called lignin sulfonates and sulfite lignins) are products of sulfite pulping. Kraft lignins (also called sulfate lignins) are obtained from the Kraft pulping process. Other delignification technologies use an organic solvent or a high pressure steam treatment to remove lignins from plants. Because lignins are very complex natural polymers with many random couplings, the exact chemical structure is not known, and the physical and chemical properties of lignin can differ depending on the extraction technology and the plant material from which it is extracted. For example, lignosulfonates are hydrophilic and Kraft lignins are hydrophobic. Lignin is typically used as a stabilizer (e.g. an antioxidant) for plastics and rubber, as well as in the formulation of dispersants, adhesives, and surfactants. Lignin or lignin derivatives have also been used in the production of fully biodegradable lignin-based composites.

Ionic liquids have recently received much attention as “green” (environmentally friendly), designable solvents, which are favorable in light of the growing realization of the need to protect the environment. Ionic liquids represent a new way of thinking with regard to solvents. The field is experiencing rapid growth, and offers a starting point for science, industry, and business to cooperate in the formation of a new paradigm of green chemistry and sustainable industry.

Ionic liquids offer a range of significant improvements upon conventional solvents, and also exhibit greater ability than water for solubilizing organic compounds. The unique structure of ionic liquids compared to traditional molecular solvents provides for many unique solubilization characteristics. For example, a range of ionic liquids applicable for the dissolution of cellulose are disclosed in U.S. Pat. No. 6,824,559. Furthermore, ionic liquids have shown good solubility characteristics for monomers or polymers and have been used to reconstitute advanced composites materials, as disclosed in International Publication WO 2005/098546.

Although using ionic liquids as solvents to process cellulose and lignocellulose have been reported, there is still a void in the art in relation to the conversion of wood lignocellulosics into new biomaterials or the chemical modification of wood based lignocellulose under homogenous conditions.

### SUMMARY OF THE INVENTION

The present invention provides methods for creating and reconstituting wood composites using a wide range of novel components based on wood and also provides synthetic polymers arising from the dissolution of lignocellulose in ionic liquids under mild conditions. Thus, the present invention provides a major pathway for the effective utilization of wood and plant based biopolymers, as well as lignin industrial by-products. The reconstitution of homogeneous lignocellulosic mixtures with various polymers and additives allows for the creation of a wide range of novel composite materials with numerous economic and societal benefits.

The ability to dissolve wood, lignin, or other lignocellulosic materials, in ionic liquid media, particularly under mild conditions, allows for the homogeneous chemical modification of the lignocellulosics. For example, the dissolved lignocellulosics can be blended with one or more polymers, copolymers, or functional additive components to prepare a variety of composite materials. Accordingly, the present invention allows for the direct preparation of lignocellulose based biodegradable advanced composite materials via reconstitution of such solutions.

The present invention has now been achieved based on the novel processing platform that utilizes ionic liquids to dissolve and/or disperse lignocellulosics, as well as other biopolymers, synthetic polymers (including copolymers and monomers), and functional additives (such as anti-UV reagents, anti-bacterial reagents, nanomaterials, and the like). The ionic liquids used in the invention are advantageous in that they can be easily recycled for a number of uses. This advanced dissolution technique can be used in the preparation of many types of composites, including membranes, fibers, nanofibers and other nanocomposites, and the like. Moreover, the dissolved materials can be easily processed by traditional technologies, including wet spinning, electrospinning, extruding, precipitation, and the like.

In certain embodiments, the invention provides ionic liquid media useful in a variety of methods. The ionic liquid media preferably comprises ionic liquid formed of an organic cation component and an anionic component. In specific embodiments, the organic cation component comprises an imidazole compound that is preferably substituted with an aromatic-containing group, such as phenyl or benzyl. The anion component can be an organic or inorganic moiety and preferably comprises a halogen.

In further embodiments, the invention is directed to methods of solubilizing one or more lignocellulose-containing materials. Preferably, the method comprises contacting the lignocellulose-containing material with an ionic liquid, as described herein.

In one aspect, the invention provides composite materials formed with lignocellulosic materials. The composite materials of the invention generally comprise lignocellulosic material that has been subject to dissolution with an ionic liquid.

In certain embodiments, the invention is directed to a composite material comprising an ionic liquid solvated lignocellulosic material in combination with a further polymeric component. The further polymeric component can comprise a natural polymer, a synthetic polymer, and combinations thereof. In particular embodiments, the further polymeric component comprises a non-polar polymer. Specific examples of polymeric materials useful in the composites include, but are not limited to, polysaccharides, polyesters, polyamides, aromatic polyamides (aramids), polyimides, polyurethanes, polysiloxanes, aromatic polymers, phenol polymers, polysulfides, polyacetals, polyolefins, halogenated polyolefins, polyethylene oxides, polyacrylates, polymethacrylates, polycarbonates, polydienes, and combinations thereof.

The composite material prepared according to the invention can take on a variety of forms. In certain embodiments, the composite material can be in the form of a solution, can be in a solid form, or can be a melt. In specific embodiments, the composite material is in the form of a fiber or membrane.

In specific embodiments, the composite material can comprise a lignocellulosic material that has been derivatized prior to combination with the further polymeric component. For example, the solvated lignocellulosic material can be chemically derivatized such that one or more naturally occurring hydroxyl moiety present in the lignocellulosic material has been replaced with a different, derivatizing chemical moiety.

Accordingly, in further embodiments, the present invention is also directed to a derivatized lignocellulosic material. The derivatized lignocellulosic material can particularly comprise an ionic liquid solvated lignocellulosic material. Derivatized lignocellulosic materials including a derivatizing chemical moiety can be particularly useful for improving the compatibility of the lignocellulosic material with further polymeric components, particularly non-polar polymers, in the formation of composite materials. Thus, it may be particularly useful for the derivatizing moiety to comprise a non-polar moiety. In certain embodiments, the derivatizing moiety comprises a group that reacts with the hydroxyl moiety on the lignocellulosic material to form an ester linkage or an ether linkage. Non-limiting examples of the types of derivatizing moieties useful according to the invention include carboxylic acids, carboxylic esters, acyl halides, acyl pseudohalides, acid anhydrides, aldehydes, ketones, carboxamides, aliphatic halides, and combinations thereof.

The derivatized lignocellulosic material according to the invention can be solubilized in an ionic liquid or can be in the form of a solid, such as a powder. The solid form of the derivatized lignocellulosic material is physically and chemically stable and can be stored for later use, such as in the preparation of a composite material with another polymer. Thus, the derivatized lignocellulosic material of the invention represents a valuable chemical commodity that can be a platform for the preparation of a variety of products.

In another aspect, the present invention is directed to methods of preparing composite materials. In certain embodiments, the methods comprise dissolving lignocellulosic material in an ionic liquid to form a solution and combining the solvated lignocellulosic material with a further polymeric component as described herein.

In specific embodiments, the method of preparing a composite material can include derivatizing the solvated lignocellulosic material prior to the step of combining the lignocellulosic material with the further polymer component. The derivatizing step can comprise combining the solvated lignocellulosic material with a derivatizing chemical moiety to replace one or more naturally occurring hydroxyl moiety present in the lignocellulosic material with the different, derivatizing moiety.

The step of combining the lignocellulosic material with the further polymer component can comprise melt processing or solution blending the solvated lignocellulosic material and the further polymeric component. Thus, the further polymeric component can be added directly to the solution of the solvated lignocellulosic material. In other embodiments, the method can comprise, prior to the combining step, regenerating the solvated lignocellulosic material to form a solid, regenerated lignocellulosic material. In such embodiments, the combining step can comprise mixing the regenerated lignocellulosic material with the further polymeric component. In one embodiment, the components are mixed to form a melt, which can be extruded to form fibers, molded to form other desired products, or otherwise processed to form composite materials having a specific form or function.

In certain embodiments, the invention also provides methods for preparing derivatized lignocellulosic materials. In one embodiment, the method comprises dissolving a lignocellulosic material in an ionic liquid to form a solution and combining the solvated lignocellulosic material with a derivatizing chemical moiety to replace one or more naturally occurring hydroxyl moiety present in the lignocellulosic material with the different, derivatizing moiety. The derivatizing moiety can comprise a non-polar moiety. In certain embodiments, the derivatizing moiety comprises a group that reacts with the hydroxyl moiety on the lignocellulosic material to form an ester linkage or an ether linkage. In specific embodiments, the derivatizing moiety is selected from the group consisting of carboxylic acids, carboxylic esters, acyl halides, acyl pseudohalides, acid anhydrides, aldehydes, ketones, carboxamides, aliphatic halides, and combinations thereof.

In some embodiments, the method of preparing a derivatized lignocellulosic material can further comprise regenerating the derivatized lignocellulosic material to form a solid, regenerated derivatized lignocellulosic material. As pointed out above, forming the regenerated derivatized lignocellulosic material provides a useful avenue for providing a valuable commodity that can find use in the preparation of a variety of materials.

A variety of ionic liquids can be used according to the methods of the invention. For example, the ionic liquid can be a material formed of a cation and an anion, wherein the cation is selected from the group consisting of imidazoles, pyrazoles, thiazoles, isothiazoles, azathiozoles, oxothiazoles, oxazines, oxazolines, oxazaboroles, dithiozoles, triazoles, delenozoles, oxaphospholes, pyrroles, boroles, furans, thiophenes, phospholes, pentazoles, indoles, indolines, oxazoles, isoxazoles, isotetrazoles, tetrazoles, benzofurans, dibenzofurans, benzothiophenes, dibenzothiophenes, thiadiazoles, pyridines, pyrimidines, pyrazines, pyridazines, piperazines, piperidines, morpholones, pyrans, annolines, phthalazines, quinazolines, guanidiniums, quinxalines, choline-based analogues, derivatives thereof, and combinations thereof, and wherein the anion is selected from the group consisting of halogens, phosphates, alkylphosphates, alkenylphosphates, BF₄⁻, PF₆⁻, AsF₆⁻, NO₃⁻, N(CN)₂⁻, N(SO₃CF₃)₂⁻, amino acids, substituted or unsubstituted carboranes, perchlorates, pseudohalogens, metal chloride-based Lewis acids, C₁₋₆ carboxylates, and combinations thereof.

The composite materials provided by the present invention can be achieved through a variety of process, such as direct blending, chemical modification, in-situ polymerization, or graft polymerization. Such methods can also comprise one or more steps, such as forming the dissolved material into a membrane, spinning the dissolved material into a fiber, extruding the dissolved material into a shaped part, or the like.

### BRIEF DESCRIPTION OF THE DRAWINGS

Having thus described the invention in general terms, reference will now be made to the accompanying drawings, which are not necessarily drawn to scale, and wherein:

FIG. 1a is photomicrograph of spruce sawdust showing its basic fibrous structure prior to dissolution in ionic liquid;

FIG. 1b is a photomicrograph of the spruce sawdust from FIG. 1a after dissolution in ionic liquid and regeneration;

FIG. 2 is the X-ray spectra of spruce sawdust undissolved, dissolved in ionic liquid, and regenerated from ionic liquid;

FIG. 3 is a flowchart illustrating the formation of composite materials according to one embodiment of the invention;

FIG. 4 is an illustration of a reaction scheme according to one embodiment of the invention for forming wood derivatives;

FIG. 5 is a torque vs. mixing time curve for the blending of 10% by weight benzoylated spruce TMP with polystyrene according to one embodiment of the invention;

FIG. 6 is a torque vs. mixing time curve for the blending of 10% wt (non-derivatized) spruce TMP with polystyrene provided as a comparative to the curve of FIG. 5;

FIG. 7 is a chart illustrating the effect of weight fraction of benzoylated spruce on the torque observed after 8 minutes of melt mixing for polystyrene/benzoylated spruce composites according to embodiments of the invention and polystyrene/(non-derivatized) spruce TMP;

FIG. 8a is a SEM micrograph of the morphology at the cut surface of a fiber formed using pure polystyrene;

FIG. 8b is a SEM micrograph of the morphology at the cut surface of a fiber formed using a composite of polystyrene and (non-derivatized) 10% spruce TMP;

FIG. 8c is a SEM micrograph of the morphology at the cut surface of a fiber formed using a composite of polystyrene and 10% benzoylated spruce TMP according to one embodiment of the invention;

FIG. 8d is a SEM micrograph of the morphology at the cut surface of a fiber formed using a composite of polystyrene and 15% benzoylated spruce TMP according to one embodiment of the invention;

FIG. 8e is a SEM micrograph of the morphology at the cut surface of a fiber formed using a composite of polystyrene and 20% benzoylated spruce TMP according to one embodiment of the invention;

FIG. 9a is a SEM micrograph of the morphology at the outer surface of a fiber prepared with a polystyrene homopolymer;

FIG. 9b is a SEM micrograph of the morphology at the outer surface of a fiber prepared with a 20% by weight benzoylated spruce/polystyrene composite according to one embodiment of the invention;

FIG. 10a is a SEM micrograph of a cross-sectional fractured surface of a fiber prepared using a polypropylene homopolymer;

FIG. 10b is a SEM micrograph of a cross-sectional fractured surface of a fiber prepared using a non-derivatized spruce TMP/polypropylene composite;

FIG. 10c is a SEM micrograph of a cross-sectional fractured surface of a fiber prepared using a 5% by weight lauroylated spruce TMP/polypropylene composite according to one embodiment of the invention; and

FIG. 10d is a SEM micrograph of a cross-sectional fractured surface of a fiber prepared using a 15% by weight lauroylated spruce TMP/polypropylene composite according to one embodiment of the invention.

### DETAILED DESCRIPTION

The invention now will be described more fully hereinafter through reference to various embodiments. These embodiments are provided so that this disclosure will be thorough and complete, and will fully convey the scope of the invention to those skilled in the art. Indeed, the invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

Biodegradable plastics and biobased composites generated from annually renewable biomass feedstocks are regarded as promising materials that could replace synthetic polymers and reduce global dependence on fossil sources. Polymer blending is a convenient method to develop advanced and novel biocomposites with tailored properties. The chemical, thermal, and physical properties of polymer blends and composites depend on the molecular weight distribution and actual composition of the respective polymers with the miscibility of the individual components being of paramount significance. Many naturally occurring polymers are of hydrophilic nature due to an abundance of hydroxyl or other polar groups. In contrast, a significant number of synthetic commodity polymeric materials are hydrophobic, nonpolar materials. In order to increase the miscibility of these hydrophobic materials with various natural polymers, chemical modification and graft polymerization of such polymers are common approaches. Nevertheless, the development of economic and abundant alternatives remains a challenge.

Wood is among the most abundant lignocellulosic resources on the planet. Accordingly, it would be highly useful to have an efficient method for the conversion of wood (as well as other lignocellulosic materials) to a form having improved or modified compatibility with thermoplastics, increased dimensional stability, and improved resistance to decay. The present invention provides an environmentally friendly, homogeneous technique for the direct conversion of lignocellulosics (and particularly wood) into novel materials (e.g., “wood thermoplastic composites” or “wood plastic composites”, both of which may be designated “WPCs”) by a variety of processes. The invention further provides a number of novel composite materials based on these processes. The resulting materials can be highly substituted with unique and distinctly different morphological and thermal characteristics from those of wood fibers and the native forms of other lignocellulosic materials. The present invention is characterized by the ability to solubilize lignocellulosic, ligninic, and cellulosic materials directly in an ionic liquid. In particular embodiments, the solubilized lignocellulosics can be combined with a number of further materials to prepare wood composites.

As more fully described below, a variety of highly substituted (e.g., alkylated, benzoylated, and carbanilated) wood based lignocellulosic materials can be produced by achieving complete dissolution of the lignocellulosics in ionic liquids and then reacting the solvated lignocellulosics with additives under defined conditions. Beneficially, the lignocellulosic derivatives synthesized by the inventive methods exhibit thermal properties that are characteristic of thermoplastic behavior.

### Ionic Liquids

Generally, ionic liquids can be defined as compounds that are comprised entirely of ions and are liquids at temperatures of less than about 100° C., preferably less than about 85° C. Materials useful as ionic liquids according to the present invention also have a liquid range of up to about 300° C., which allows for good kinetic control. Such ionic liquids are excellent solvents for a wide range of inorganic, organic, and polymeric materials (high solubility generally meaning only small reactor volumes are necessitated and process intensification is provided). Preferentially, the ionic liquids can exhibit Brønsted, Lewis, and Franklin acidity, as well as superacidity, enabling many catalytic processes. They have no effective vapor pressure, are both hydrophilic and hydrophobic systems (further enhancing their industrial application), and are thermally stable up to about 200° C., preferably about 250° C., and more preferably about 300° C. Ionic liquids offer a wide variety of possible solvents allowing for process optimization (there are over a million (10⁶) simple ionic liquids, and over a trillion (10¹⁸) ionic liquid combinations). Ionic liquids are further beneficial in that they are relatively inexpensive (particularly in light of their facile recycling potential), easy to prepare, and commercially available.

As used in the present invention, ionic liquids generally comprise one or more anions and one or more cations. In preferred embodiments, the ionic liquids comprise organic cations created by derivatizing one or more compounds to include substituents, such as alkyl, alkenyl, alkynyl, alkoxy, alkenoxy, alkynoxy, a variety of aromatics, such as (substituted or unsubstituted) phenyl, (substituted or unsubstituted) benzyl, (substituted or unsubstituted) phenoxy, and (substituted or unsubstituted) benzoxy, and a variety of heterocyclic aromatics having one, two, or three heteroatoms in the ring portion thereof, said heterocyclics being substituted or unsubstituted. The derivatized compounds include, but are not limited to, imidazoles, pyrazoles, thiazoles, isothiazoles, azathiozoles, oxothiazoles, oxazines, oxazolines, oxazaboroles, dithiozoles, triazoles, delenozoles, oxaphospholes, pyrroles, boroles, furans, thiophenes, phospholes, pentazoles, indoles, indolines, oxazoles, isoxazoles, isotetrazoles, tetrazoles, benzofurans, dibenzofurans, benzothiophenes, dibenzothiophenes, thiadiazoles, pyridines, pyrimidines, pyrazines, pyridazines, piperazines, piperidines, morpholones, pyrans, annolines, phthalazines, quinazolines, guanidiniums, quinxalines, choline-based analogues, and combinations thereof. The basic cation structure can be singly or multiply substituted or unsubstituted.

The anionic portion of the ionic liquid can comprise an inorganic moiety, an organic moiety, or combinations thereof. In preferred embodiments, the anionic portion comprises one or more moieties selected from halogens, phosphates, alkylphosphates, alkenylphosphates, bis(trifluoromethylsulfonyl)imide (NTf₂), BF₄⁻, PF₆⁻, AsF₆⁻, NO₃⁻, N(CN)₂⁻, N(SO₃CF₃)₂⁻, amino acids, substituted or unsubstituted carboranes, perchlorates, pseudohalogens such as thiocyanate and cyanate, metal chloride-based Lewis acids (e.g., zinc chlorides and aluminum chlorides), or C₁₋₆ carboxylates. Pseudohalides are monovalent and have properties similar to those of halides (see, Schriver et al., Inorganic Chemistry, W. H. Freeman & Co., New York (1990) 406-407, which is incorporated herein by reference). Examples of pseudohalides useful according to the invention include cyanides, thiocyanates, cyanates, fulminates, and azides. Exemplary carboxylates that contain 1-6 carbon atoms are formate, acetate, propionate, butyrate, hexanoate, maleate, fumarate, oxalate, lactate, pyruvate and the like. Of course, such list is not intended to be an exhaustive listing of all possible anionic moieties possible according to the invention. Rather, a variety of further anionic moieties are also envisioned and encompassed by the present invention. For example, the invention also encompasses ionic liquids based on alkyl imidazolium or choline chloride anol-aluminum chloride, zinc chloride, indium chloride, and the like. Moreover, various further Lewis acid inorganic salt mixtures may be used (see Green Chem. (2005) 7, 705-707, which is incorporated herein by reference).

As noted above, a variety of ionic liquids can be prepared and used according to the present invention. In particular, any combination of the cations and anions noted above could be used. It is only necessary to combine one or more cations (such as those described above) with one or more anions (such as those described above) to form a material that is liquid under the conditions described herein. For example, a cation imidazolium moiety could be combined with an anionic halogen moiety to form a material that is liquid under the requisite conditions (e.g., 1-butyl-3-methyl-imidazolium chloride) and that is formed substantially completely of ionic moieties. Thus, it is clear that the present invention encompasses the use of a great diversity of ionic liquids. Specific, non-limiting examples of ionic liquids for use according to the invention include 1-butyl-3-methyl-imidazolium chloride (“BmimCl”); 1-allyl-3-methyl-imidazolium chloride (“AmimCl”); 1-ethyl-3-methyl-imidazolium chloride; 1-hydrogen-3-methyl-imidazolium chloride; 1-benzyl-3-methyl-imidazolium chloride (“BenzylmimCl”); 1-isopropyl-3-methyl-imidazolium chloride; 1-m-methoxybenzyl-3-methyl-imidazolium chloride (“MethoxyBenzylmimCl”); 1-m-methylbenzyl-3-methyl-imidazolium chloride (“MethylBenzylmimCl”); 1-benzyl-3-methyl-imidazolium chloride, and 1-methyl-3-benzyl-imidazolium dicyanamide (“BenzylmimDca”). These exemplary compounds are illustrated below in Formulas (1) through (6).

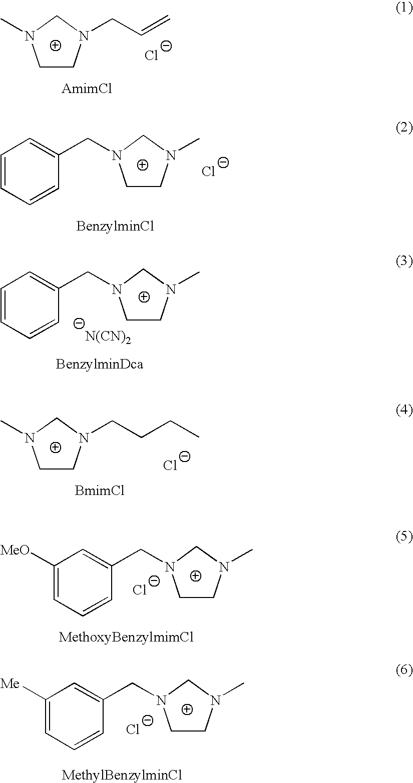

Exemplary methods for preparing ionic liquids of BenzylmimCl and BenzylmimDca are provided in Examples 1 and 2, respectively.

In still further embodiments, the present invention encompasses the uses of various ionic liquids incorporating phosphates as the anionic portion. Specific, non-limiting examples of such phosphate-containing compounds useful as ionic liquids include: bis[1,3-dimethylimidazolium]methylphosphate—Formula (7); tris[1,3-dimethylimidazolium] phosphate—Formula (8); 1,3-dimethylimidazolium diallylphosphate—Formula (9); 1,2,3-trimethylimidazolium dimethylphosphate—Formula (10); 1-benzyl-3-methylimidazolium dimethylphosphate—Formula (11); 1-vinyl-3-methylimidazolium dimethylphosphate—Formula (12); 1,3-dimethylimidazolium dimethylphosphate—Formula (13); 1,2,3-trimethylimidazolium methylhydrogenphosphate—Formula (14); and 1-allyl-3-methylimidazolium dimethylphosphate—Formula (15). Related compounds can be prepared by transesterification of the phosphate anion with an alcohol such as, allyl alcohol.

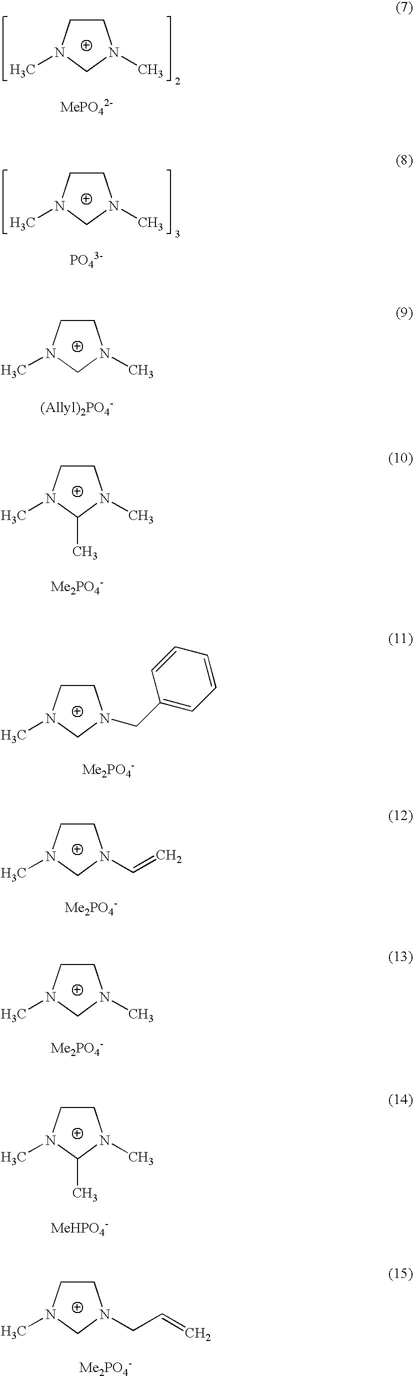

Phosphate-containing ionic liquids can be particularly useful according to the present invention. Such compounds are typically relatively easy to prepare by synthesis methods, they readily dissolve woody lignocellulosic materials, and ionic liquids based on such materials exhibit viscosities in ranges making them particularly easy to use without the need for excessive heating. For example, when compared to halide-based ionic liquids (especially chloride-based ionic liquids), phosphate-based ionic liquids, such as those noted above, exhibit viscosities in the range of three to five times less than the viscosities typically exhibited by the halide-based ionic liquids.

Although the ionic liquids exemplified above in Formulas (1) through (15) use imidazole cation, the present invention should not be limited only to the use of imidazole cationic moieties. Rather, as previously noted, the imidazole series of ionic liquids are only representative of the types of ionic liquids that can be used according to the invention. For example, in Formulas (1) though (15), the imidazole cation could be replaced with a pyridinium cation. Thus, the invention clearly also encompasses liquids formed of compounds as illustrated in Formulas (1) through (15) but wherein the cationic portion is a pyridinium cation. In other words, the invention particularly encompasses pyridinium chlorides and pyridinium phosphates. In specific embodiments, the ionic liquids useful according to the invention encompass allyl-methyl-pyridinium chloride, ethyl-methyl-pyridinium chloride, methyl-pyridinium chloride, benzyl-methyl-pyridinium chloride, isopropy-1-methylpyridinium chloride, 1-m-methoxybenzyl-methyl-pyridinium chloride, 1-m-methylbenzyl-methyl-pyridinium chloride, or benzyl-methyl-pyridinium chloride. Likewise, it is clear that multiple pyridinium phosphate ionic liquids could be used based on the compounds of Formulas (7) through (15) wherein the imidazolium cation is substituted with a pyridinium cation. Based on this disclosure, it is also clear how to arrive at still further ionic liquids for use according to the invention. For example, useful ionic liquids could be based on an imidazolium cation or a pyridinium cation paired with any suitable anion as described above. Likewise, useful ionic liquids could be based on a chloride anion or a phosphate anion paired with any suitable cation as described above.

As previously pointed out, the ionic liquids used according to the invention can encompass one or more cations combined with one or more anions. In specific embodiments, the invention comprises the use of cation liquids formed of dicationic compounds. Dicationic materials can exhibit increased thermal stability and are thus useful in embodiments where it may be desirable to carry out the dissolution of lignocellulosic materials at increased temperature. Dicationic ionic liquids can be prepared using any combination of cations and anions, such as those described above. For example, imidazoles and pyridines could be used in preparing dicationic ionic liquids in a similar manner as the ionic liquids described above using only a single cationic moiety.

In certain embodiments, the invention encompasses dicationic liquids having the structure provided below in Formulas (16) and (17)

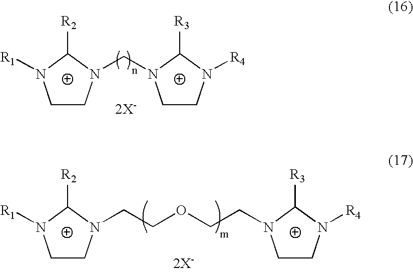

wherein n is an integer from 4 to 10; m is an integer from 1 to 4; X is a cationic moiety selected from the group consisting of Cl, Br, I, NTf₂, (R)₂PO₄, and RHPO₄; and R, R₁, R₂, R₃, and R₄ are independently selected from the group consisting of H, C₁₋₆ alkyl, C₁₋₆ alkenyl, and C₁₋₆ alkynyl. One specific example of a dicationic ionic liquid according to Formula (16) that is useful according to the present invention is the compound shown below in Formula (18).

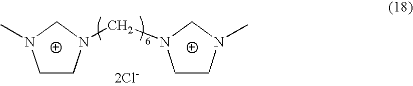

In further embodiments, the invention also encompasses dicationic liquids having the structure provided below in Formulas (19) and (20)

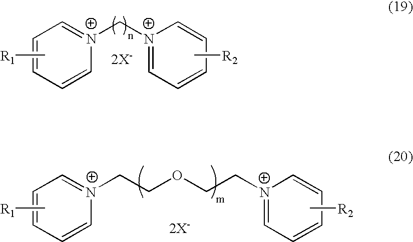

wherein n is an integer from 4 to 10; m is an integer from 1 to 4; X is a cationic moiety selected from the group consisting of Cl, Br, I, bis(trifluoromethylsulfonyl)imide (NTf₂), (R)₂PO₄, and RHPO₄; and R, R₁, and R₂ are independently selected from the group consisting of H, C₁₋₆ alkyl, C₁₋₆ alkenyl, and C₁₋₆ alkynyl. Dicationic compounds useful as ionic liquids according to the present invention can be prepared through synthesis methods known in the art. See, for example, J. Chem. Technol Biotechnol., 81 (2006), p. 401-405, which is incorporated herein by reference in its entirety.

The invention also encompasses the use of various mixtures of ionic liquids. In fact, ionic liquid mixtures can be useful for providing ionic liquids having customized properties, such as viscosity. For example, BenzylmimCl is a relatively viscous ionic liquid; however, it viscosity can be significantly reduced by mixing with AmimCl. The viscosity of the ionic liquid mixture can thus be adjusted by varying the ratio between the more viscous component and the less viscous component.

Of course, in light of the above disclosure around suitable cationic moieties and suitable anionic moieties, the present invention also encompasses the many ionic liquids that can be prepared through suitable combinations of the disclosed cationic moieties and anionic moieties. Various further ionic liquids useful according to the invention are disclosed in U.S. Pat. No. 6,824,599, which is incorporated herein by reference.

Aromatic group-containing ionic liquids are particularly useful according to the invention. While not wishing to be bound by theory, it is believed that π-π interactions among the aromatic groups in lignin may account for the conformationally stable supermolecular structure of lignin. Thus, cationic moieties with an electron-rich aromatic π-system can create stronger interactions for polymers capable of undergoing π-π and π-π interactions. In particular, the aromatic character of the imidazolium ring of an ionic liquid cation offers potential π-π interactions with many aromatic moieties. Phenyl-containing ionic liquids provide particularly good solubilization of woody materials, as well as lignocellulosic materials generally.

Ionic liquids for use according to the invention can be synthesized according to the literature. Preferably, the ionic liquids are dried (e.g., at 100° C.) in a vacuum oven over a period of time, such as about 48 hours, prior to use. In one embodiment, the ionic liquid is formed of a material that is solid (e.g., crystalline) at ambient conditions but is liquid at increased temperature (such as greater than about 30° C., greater than about 40° C., greater than about 50° C., greater than about 75° C., greater than about 85° C., or greater than about 100° C.). Generally, the crystalline material can be placed in an appropriated container and heated to dissolution. See, for example, Ionic Liquids in Synthesis, Wasserscheid, P. and Weldon, T. (Eds.), Wiley Pub., which is incorporated herein by reference. Of course, the ionic liquid can also comprise a material that is liquid at ambient conditions (e.g., at a temperature around 20-25° C.). In particular, the present invention can encompass ionic liquids that are liquid at a temperature of about −10° C. to about 150° C., about 0° C. to about 150° C., or about 15° C. to about 150° C. Further, various ionic liquids are provided in prepared form, such as BASIONICS™ (available from BASF), which are imidazolium-based ionic liquids that are available in standard, acidic, basic, liquid-at-room-temperature, and low-viscosity forms.

### Cellulosics and Lignocellulosics

Cellulose is a polysaccharide formed of 1,4-linked glucose units and is the primary structural component found in plants. Cellulose is the most abundant organic chemical on earth, and there is an estimated annual biosphere production of approximately 90×10⁹ metric tons of the material. When measured in energy terms, the amount of carbon synthesized by plants is equivalent to about ten times the currently estimated global energy consumption.

Lignin is a compound that is most commonly derived from wood and is an integral part of the cell walls of plants. It is a three-dimensional amorphous natural polymer containing phenylpropane units that are tri- or tetra-substituted with hydroxyl groups and methoxyl groups. Lignin makes up about one-quarter to one-third of the dry mass of wood and generally lacks a defined primary structure. Lignocellulose is primarily a combination of cellulose, lignin, and hemicellulose. It is generally thought to be practically impossible to dissolve wood in its native form because the three-dimensional lignin network binds the whole wood architecture together. For example, in papermaking, the lignin network is fragmented under alkaline conditions, and cellulose is harvested as cellulose fibers. The insolubility of wood in common solvents has severely hampered the development of new methods for the efficient utilization of wood and its components. As described below, however, though the use of ionic liquids, it is possible to achieve complete dissolution of lignocellulosics, include wood in its native form.

Accordingly, the invention is particularly characterized in that a wide variety of cellulosics and lignocellulosics can be used as the biomass. For example, the biomass used in the invention can be derived from both herbaceous and woody sources. Non-limiting examples of herbaceous biomass sources useful according to the invention include tobacco, corn, corn stovers, corn residues, cornhusks, sugarcane bagasse, castor oil plant, rapeseed plant, soybean plant, cereal straw, grain processing by-products, bamboo, bamboo pulp, bamboo sawdust, and energy grasses, such as switchgrass, miscanthus, and reed canary grass.

The invention is particularly characterized by it efficacy toward the dissolution of different woody lignocellulosic materials. A variety of hardwoods and softwoods can be used in the invention in a multitude of different forms, such as chips, shreds, fibers, sawdust, and other physical forms. In a preferred embodiment, wood for use in the invention is in the form of dust or powder, such as ball milled powder.

Dissolution in ionic liquids according to the present invention is particularly beneficial in that it has shown to be effective for use with softwoods. This is significant since the hydrolysis of softwood species is typically very low compared with hardwood species and other lignocellulosic materials when most of the current technologies are applied. Therefore, the method of the present invention provides a potential technique for biofuel production using softwood species, which are generally more abundant, and faster growing, than most hardwood species.

Softwood is a generic term typically used in reference to wood from conifers (i.e., needle-bearing trees from the order Pinales). Softwood-producing trees include pine, spruce, cedar, fir, larch, douglas-fir, hemlock, cypress, redwood and yew. Conversely, the term hardwood is typically used in reference to wood from broad-leaved or angiosperm trees. The terms “softwood” and “hardwood” do not necessarily describe the actual hardness of the wood. While, on average, hardwood is of higher density and hardness than softwood, there is considerable variation in actual wood hardness in both groups, and some softwood trees can actually produce wood that is harder than wood from hardwood trees. One feature separating hardwoods from softwoods is the presence of pores, or vessels, in hardwood trees, which are absent in softwood trees. On a microscopic level, softwood contains two types of cells, longitudinal wood fibers (or tracheids) and transverse ray cells. In softwood, water transport within the tree is via the tracheids rather than the pores of hardwoods.

Still further, various lignocellulosics generally regarded as “waste” materials can be used according to the present invention. For example, materials that have heretofore been discarded or thought of little value, such as corn stover, rice straw, paper sludge, and waste papers, can all be used as a lignocellulosic starting material according to the present invention. Particularly, it is possible to use various grades of paper and pulp, including recycled paper, which include various amounts of lignins, recycled pulp, bleached paper or pulp, semi-bleached paper or pulp, and unbleached paper or pulp. Such papers and pulps can be of various lignin contents and origins.

The present invention may be described herein in terms of lignocellulosic materials; however, such term does not necessarily exclude the use of materials that may more specifically be defined as cellulosic materials or ligninic materials. Rather, the term lignocellulosic is intended to broadly refer to biomass that may be primarily formed of cellulose, lignin, or lignocellulose. Thus, as used herein, lignocellulosic can mean materials derived from woody sources, grassy sources, and other plant sources generally. Specifically, lignocellulosic can mean a material comprised partly or mainly of lignin, cellulose, or lignocellulose.

### Composite Additives

The unique salvation properties of ionic liquids allow for the dissolution of a wide range of polymers (in addition to the lignocellulosic materials), which in turn allows for the creation of new materials with adjustable properties based on lignocellulose. Ionic liquids provide a unique opportunity for multiple polymer dissolution, which allows for the formation of blends based on lignocellulose comprising binary, ternary and multi-component systems. The reconstituted resins from non-solvents find applications in engineering materials, extruded objects, fibers, beads, blends, membranes and other novel applications. The unique electrochemical and catalytic properties of ionic liquids combined with their ability to dissolve lignocellulose accompanied by satisfactory mechanical properties allow for the formation of a variety of lignocellulose/ionic liquid blends, which could see applications in electrochemistry, membrane reactors, and separation science.

In certain embodiments, the invention provides composite materials comprising solubilized lignocellulosics, particularly solubilized wood, and one or more polymeric additives that contain various repeating monomeric units. These monomer units may contain polar, non-ionic, and charged groups including, but not limited to, —NH₂—, —NHR, —NR₂, —N⁺R₃X⁻, —O—, —OH, —COOH, —COO—, M⁺, —SH, —SO₃⁻M⁺, —PO₃⁻M₂⁺, —PR₃, —NH—CO—NH₂ and —NHC(NH)NH₂. These groups may be present in sufficient numbers along, or pendent to, the polymeric backbone, in a number of polymers. Non-limiting examples of such polymers useful for combination with lignocellulosic materials as described herein to prepare composite materials include polyacrylamides, polyvinyl alcohols, polyvinyl acetates, poly(N-vinylpyrrolidinones) and poly(hydroxyethyl acrylates).

These groups present on the polymer used to form the composite material can affect the solubility of the emerging composite materials. The formed composite materials can have a complex structure due to intramolecular hydrogen bonding, ionic interactions, intermolecular interactions, and chain-chain complexation. These interactions govern the solution properties and performance. Further properties such as polarity, charge, hydrogen bonding interactions between the polymer and the solvent are also important for effective dissolution and blending.

The viscosity characteristics of the emerging solutions can also be an important consideration, particularly in relation to ease of processing. As previously pointed out, choice of ionic liquid (or mixtures thereof) and processing temperature are two factors that can impact the solution viscosity. Moreover, it can be useful to include provisions for taking detailed viscosity measurements during the dissolution process to observe the changes in viscosity. This can particularly provide means of quality control and monitoring of the efficiency of the dissolution.

Suitable polymers and copolymers for use in the present invention for forming composite materials can be formed by step, chain, ionic, ring-opening, and otherwise catalyzed polymerizations. They can be derived from natural and synthetic sources, including, but are not limited to, polysaccharides, polyesters, polyamides, aromatic polyamides (aramids), polyimides, polyurethanes, polysiloxanes, aromatic polymers, phenol polymers, polysulfides, polyacetals, polyolefins, halogenated polyolefins, polyethylene oxides, polyacrylates, polymethacrylates, polycarbonates, and polydienes.

Non-limiting examples of specific polymers that may be used in the preparation of composites according to the invention include: starch, chitin, chitosan, silk, keratin, poly-2-hydroxymethylmethacrylate, polybenzoimide, polyvinyl alcohol, polyanilidine, polyethylene glycol, polyethyleneimine, polystyrene, polyethylene, polypropylene, polyethylene terephthalate, polypropylene terephthalate, polyvinylchloride, polyurethane, branched polyethyleneimine, cellulose acetate, cellulose acetate butyrate, cellulose acetate propionate, carbon fiber reinforced plastics, cellulose nitrate, cellulose propionate, cellulose triacetate, chloro-trifluoroethylene, ethyl cellulose, ethylene-chlorotrifluoroethylene, epoxide resin, methyl cellulose, melamine formaldehyde, Nylon, polyacrylonitrile, polyaryl sulphone, polybenzimidazole, polybutyl methacrylate, polybutylene terephthalate, polycarbonate, poly ether-ether-ketone, poly ether-imide, polyethersulphone, polyhydroxybutyrate, polyhydroxyvalerate, polyimide, polymethyl methacrylate, polyoxymethylene (Acetal), polyphenylene ether, polypyromellitimide, polyphenylene oxide, polyphenylene sulphide, polyphenylene sulphone, polysulphone, polytetrafluoroethylene, polytetramethylene terephthalate, polyvinyl acetate, polyvinyl alcohol, polyvinyl butyral, polyvinyl chloride, polyvinylidene chloride, polyvinylidene fluoride, polyvinyl fluoride, polyvinylidene fluoride, polyvinyl formal, polyvinyl carbazole, and polyvinyl toluene.

Non-limiting examples of specific monomers that can be used in various embodiments to form polymers for use in forming composite materials include, but are not limited to, α-olefins, 2-hydroxyalkylmethacrylate, aniline, acrylonitrile, ethylene, propylene, isobutylene, styrene, vinyl chloride, vinyl acetate, vinyl alcohol, methyl methacrylate, ethylene glycol, cellobiose, vinylidene chloride, tetrafluoroethylene, formaldehyde, acetaldehyde, vinylpyrrolidinone, butadiene, and isoprene. Further, the polymers used in forming composites according to the invention can be in the form of homopolymers, copolymers, terpolymers, block polymers, graft polymers, cross-linked polymers, and any other polymeric structure commonly used in the preparation of commercial products.

A variety of conventional additives used in polymeric formulations also can be incorporated into the composites of the present invention. The additives can be included in addition to, or in place of, the polymeric components noted above. If these additives are incorporated during the dissolution stage of the blend, it is important that they do not interfere with the solute-solvent and solvent-solvent interactions facilitating the dissolution of the lignocellulosics. Non-limiting examples of additives that can be used according to the invention include plasticizers, fillers, colorants, anti-UV agents, anti-bacterial agents, antioxidants, and nanomaterials.

In specific embodiments, one or more cross-linker additives may be included in the composite material. Cross-linking is particularly beneficial for increasing the mechanical integrity of derivatives formed of solubilized lignocellulosics according to the invention. In preferred embodiments, the use of cross-linkers facilitates the production of lignocellulosic-derived hydrogels. These are a new class of materials that provide tunable swelling characteristics that can make them particularly useful. For example, such hydrogels can be used in pharmaceuticals for providing encapsulation properties, as well as allowing for controlled release of pharmaceutically active materials. Any known cross-linker could be used according to the invention. For example cross-linking could be performed with compounds, such as glycidyl methacrylate and 1,4-phenylene diisocyanate.

The polar nature of a lignocellulosic substrate hinders miscibility and compatibility in the creation of blends of wood and/or lignin with synthetic polymers. The present invention is thus particularly beneficial since ionic liquids allow for the complete dissolution of the lignocellulosic material, and such complete dissolution makes all available reactive sites on the constituent biopolymers available for the performance of homogeneous derivatization chemistry. The emerging new material is thus ready to be blended and processed with a variety of synthetic high tonnage or specialty polymers with minimal phase separation concerns. Non-limiting examples of such chemicals for blending with the solvated lignocellulosic material include phenyl isocyanate, phthalic anhydride, benzoyl chloride, benzoyl esters, acetyl chloride, acetic anhydride, and acid chlorides or esters of C₄₋₃₀ aliphatic carboxylic acids. In addition, a variety of vinylic monomers (i.e., styrene, substituted styrenes, acrylates, methacrylates, as well as varieties of such monomers of variable hydrophilic and/or hydrophobic and/or amphiphilic character) may also be incorporated into the solution. This can allow for a free radical chain initiation process that leads to the formation of a completely new set of interpenetrating polymer networks (IPN's).

### Dissolution of Lignocellulosic Materials in Ionic Liquids

The ability to prepare a variety of composite materials according to the present invention arises from the improved reactivity of lignocellulosics, such as wood, solvated in an ionic liquid. Dissolution in ionic liquid alters the basic structure of the lignocellulosic material and makes it particularly amenable to combination with materials to which wood has not heretofore been sufficiently combinable to be useful. In certain embodiments, the method can comprise dissolving one or more lignocellulosic materials in an ionic liquid and using the material reconstituted therefrom to prepare a material, such as a membrane, fiber, or nanomaterial. The dissolution of the lignocellulosic material can be carried out under a variety of conditions.

The dissolution of the lignocellulosic material can be carried out under a variety of conditions. For example, in specific embodiments, the ionic liquid is in the substantial absence of water (i.e., is substantially free of water). In other embodiments, the ionic liquid is in the substantial absence of a nitrogen-containing base (i.e., is substantially free of any nitrogen-containing base). The phrases “substantial absence” and “substantially free” are used synonymously to mean that the ionic liquid comprises less than about 5% by weight water and/or less than about 5% by weight of a nitrogen-containing base. In one embodiment, the ionic liquid comprises less than about 5% by weight water. In another embodiment, the ionic liquid comprises less than about 5% by weight of a nitrogen-containing base. In yet another embodiment, the ionic liquid comprises less that about 5% by weight of water and nitrogen-containing base combined. In particularly preferred embodiments, the ionic liquid comprises less than about 1% by weight water and/or nitrogen-containing base. In specific embodiments, the ionic liquid is completely free of water, is completely free of nitrogen-containing base, or is completely free of both water and a nitrogen-containing base.

The lignocellulosics can be added to the ionic liquid media and the admixture can be agitated until dissolution is complete. Heat can be provided to the mixture in certain embodiments, such as in an ultrasonic bath, an oil bath or, by microwave irradiation. The ionic liquid is preferably molten at a temperature of less than about 150° C., more preferably less than about 100° C., more preferably less than about 85° C. Such temperatures are likewise sufficient to dissolve the lignocellulosics in the ionic liquid. Preferably, dissolution is carried out such that the reaction mixture of the ionic liquid and the lignocellulosic material is maintained under an inert atmosphere. In one embodiment, the dissolution is carried out under an argon atmosphere. In another embodiment, the dissolution is carried out under a nitrogen atmosphere. This is particularly useful to avoid introduction of water into the ionic liquid. Reaction according to the invention can be carried out, however, with the reaction vessel open to the atmosphere so long as relative humidity is low so as to avoid the presence of excess water in the air around the reaction vessel.

Complete dissolution of lignocellulosic materials, including wood in its native form, can be achieved by simply mixing the lignocellulosic material with the ionic liquid. Preferably, the mixing is carried out at a temperature suitable to maintain the liquid state of the ionic liquid. In certain embodiments, the mixing is carried out at a temperature of about 50° C. to about 150° C., about 60° C. to about 140° C., about 70° C. to about 130° C., or about 80° C. to about 120° C. Although increasing temperature tends to reduce the time to total dissolution, it is possible to obtain total dissolution at even ambient temperature. For example, when wood sawdust is gently homogenized with AmimCl in a mortar and the sample is subsequently transferred into a test tube (under argon), the mixture slowly turns to liquid (complete dissolution) over time. Temperature can also be influenced by the ionic liquid composition. Ionic liquids with lower viscosities can be used at lower temperatures, while ionic liquids with higher viscosities can require higher temperatures.

Preferably, the reaction parameters for the dissolution are coordinated so that complete dissolution is achieved in a desired time. For example, in certain embodiments, complete dissolution is achieved in a time of less than about 48 hours, less than about 36 hours, less than about 24 hours, less than about 18 hours, less than about 12 hours, less than about 10 hours, less than about 8 hours, less than about 6 hours, less than about 4 hours, less than about 2 hours, or less than about 1 hour. Of course, the time to complete dissolution can vary according to the various embodiments of the invention and be related to factors, such as the nature of the ionic liquid, the charge of lignocellulosic material in the ionic liquid, the applied temperature, and the degree of material diminution.

Dissolution can also be facilitated through application of mechanical stirring using any known stirring means. Achieving complete dissolution of even wood fibers has been demonstrated using a hot stage optical microscopy investigation of Norway spruce sawdust sample in AmimCl. Optical photomicrographic analysis of wood dissolution as a function of time at a temperature of 120° C. indicated that, after four hours, any visible fibrous material was completely dissolved by the ionic liquid.

Depending upon the nature of the lignocellulosic material, it may be further useful for dissolution to be carried out with further considerations. For example, the dissolution rate of wood can be dependant upon the particle size of the wood. It is believed that the complex and compact structure of the wood cell wall between the lignin, cellulose, and hemicellulose would essentially inhibit the diffusion of the ionic liquid into its interior, resulting in only a partial dissolution of wood chips. Accordingly, solubility of lignocellulosics, particularly wood in its native form, can be increased through sample preparation. Solubilization efficiency of lignocellulosic materials in ionic liquids can be defined, in certain embodiments, as follows (shown on a decreasing solubilization basis): ball-milled wood powder>sawdust>thermomechanical pulp fibers>wood chips. For example, the dissolution of fine sawdust (Norway spruce, particle size=0.1-2 mm) in ionic liquid has been shown to take place within a few hours, even under ambient conditions.

In specific embodiments, the present invention is particularly characterized by the achievement of complete dissolution of the lignocellulosic material in the ionic liquid to form a true solution. By contrast, it is possible to form a well dispersed gelatinous, highly swollen mixture of a lignocellulosic material and ionic liquid. Such mixtures do not necessarily provide the lignocellulosic material in a form that facilitates the later beneficial uses of the completely solvated lignocellulosic material, such as the formation of biofuels described below. Through use of the specific pretreatment parameters provided herein, and particularly application of continuous mechanical agitation during dissolution, it is possible to form a true solution, particularly a wood solution (i.e., wood completely solubilized in ionic liquid).

The solvated lignocellulosics are in a state making them particularly open to further modification, such as combination with various polymers and other additives, even materials with which wood would not normally be expected to be successfully combined. The solubility limit of lignocellulosics in the ionic liquids can vary depending upon the choice of ionic liquid, the choice of lignocellulosic material, and the physical state of the lignocellulosic material. In certain embodiments, it is possible according to the invention to form solutions having a lignocellulosic concentration of up to about 20% by weight, based upon the overall weight of the solution. In other embodiments, it is possible to form solutions having lignocellulosic concentrations of up to about 18% by weight, up to about 16% by weight, up to about 14% by weight, up to about 12% by weight, up to about 10% by weight, up to about 9% by weight, up to about 8% by weight, up to about 7% by weight, up to about 6% by weight, or up to about 5% by weight, based on the overall weight of the solution. In specific embodiments, the solution comprises about 2% to about 20% by weight, about 2% to about 16% by weight, about 2% to about 12% by weight, about 2% to about 10% by weight, about 2% to about 8% by weight, or about 5% to about 8% by weight of the lignocellulosic material. Table 1 provides the dissolution behavior of various wood-based lignocellulosic materials in different imidazolium-based ionic liquids.

TABLE 1

| Sam- | Ionic | | | Wt. |
|---|---|---|---|---|
| ple | Liquid | Wood Sample Form | Conditions | % |
| 1 | BmimCl | Wood chips | 130° C., 15 h | ** |
| 2 | AmimCl | Ball-milled Southern | 80° C., 8 h | 8% |
| | | pine powder | | |
| 3 | AmimCl | Norway spruce sawdust | 110° C., 8 h | 8% |
| 4 | AmimCl | Norway spruce sawdust | 80° C., 24 h | 5% |
| 5 | BmimCl | Norway spruce sawdust | 110° C., 8 h | 8% |
| 6 | AmimCl | Norway spruce TMP | 130° C., 8 h | 7% |
| 7 | BmimCl | Norway spruce TMP | 130° C., 8 h | 7% |
| 8 | AmimCl | Southern pine TMP | 110° C., 8 h | 2% |
| 9 | AmimCl | Southern pine TMP | 130° C., 8 h | 5% |
| 10 | BmimCl | Southern pine TMP | 130° C., 8 h | 5% |
| 11 | BenzylmimCl | Southern pine TMP | 130° C., 8 h | 5% |
| 12 | BenzylmimCl | Norway spruce TMP | 130° C., 8 h | 5% |
| 13 | MethoxyBen- | Southern pine TMP | 130° C., 8 h | 5% |
| | zylmimCl | | | |
| 14 | MethoxyBen- | Southern pine TMP | 130° C., 8 h | 2% |
| | zylmimCl | | | |
| 15 | BenzylmimDca | Southern pine TMP | 130° C., 8 h | 2% |

** Sample showed only partial solubility

The ability to achieve complete dissolution of lignocellulosics (especially wood) is particularly useful in light of the complex nature of lignocellulosics, as previously noted. The highly crystalline character of cellulose in wood is driven by a set of regular intermolecular and intramolecular hydrogen-bonding interactions that when coupled with the three-dimensional network character of lignin and its possible covalent linkages with the carbohydrates are primarily responsible for the complex and compact structure of wood. For example, π-π interactions among the aromatic groups in lignin have been suggested as accounting for the conformationally stable supermolecular structure of lignin. Ionic liquids have a more complex solvent behavior compared with traditional solvents, and that complex solvent behavior can include π-π, n-π, hydrogen bonding, dipolar, and ionic/charge-charge types of interactions between the ionic liquids and their solutes. It has been reported that although the Bmim cation does not have the analogous electron aromatic system, the chloride anion (with nonbonding electrons), in combination with the Bmim cation, forms an ionic liquid that exhibits the ability to interact with π-systems of certain molecules. For example, the active chloride ions in ionic liquids, such as BmimCl and other ionic liquids described herein, may disrupt the hydrogen-bonding interactions present in wood, allowing it to diffuse into the interior of the wood.

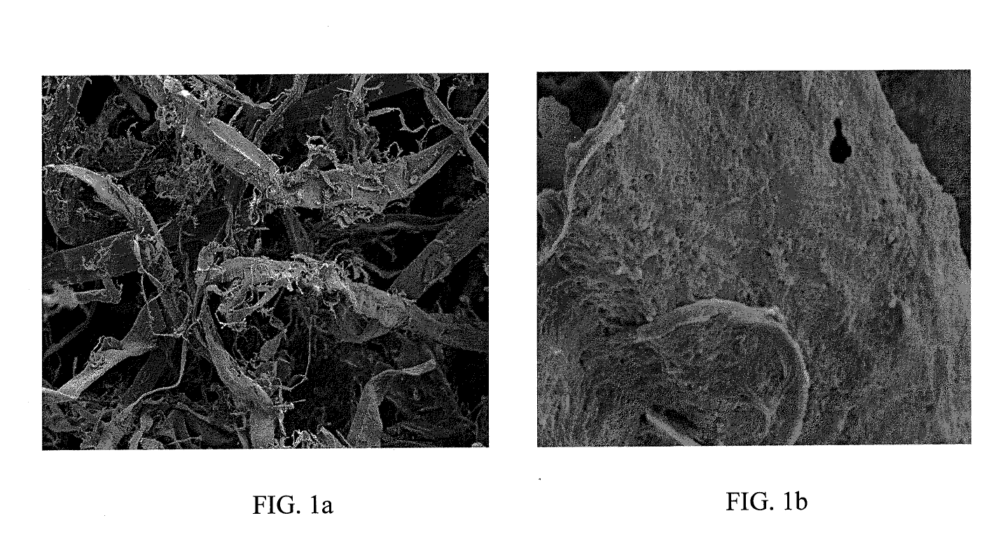

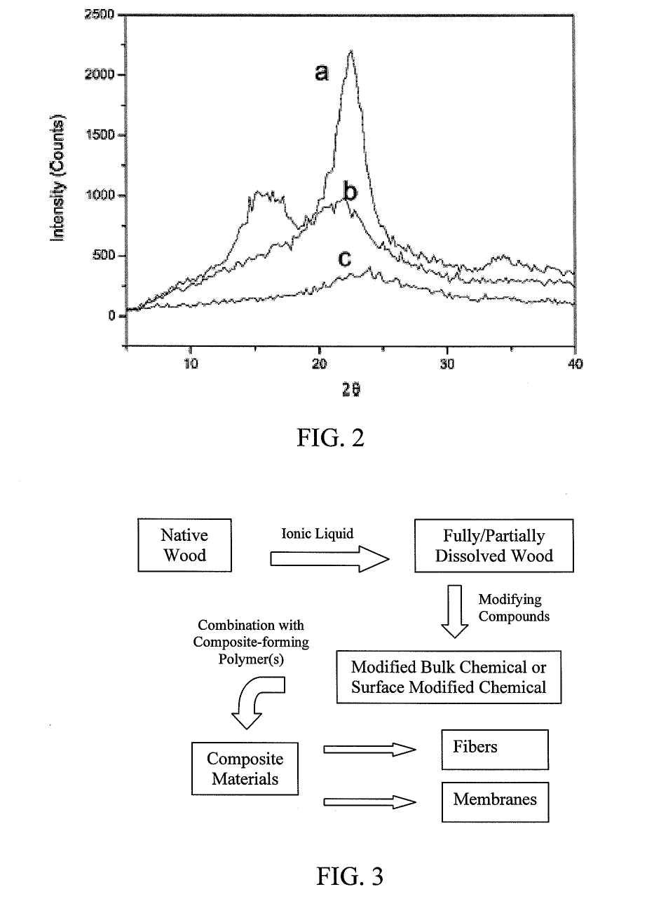

After dissolution of the lignocellulosic material, the solvated (optionally derivatized) material can be isolated from the mixture through use of a regenerating solvent. Such regenerating solvent can be any polar solvent, such as water or alcohols. Such precipitation is typically spontaneous upon the addition of the regenerating solvent, and the precipitated material can be physically separated from the mixture. In one embodiment, regeneration under rapid mechanical stirring results in the formation of a fully amorphous material. This is illustrated in FIG. 1a and FIG. 1b. FIG. 1a is a photomicrograph of spruce sawdust before dissolution in ionic liquid (AmimCl), and the fibrous nature of the material is clearly evident. FIG. 1b, however, is a photomicrograph of the same sawdust after dissolution in ionic liquid and regeneration by precipitation in water. As seen in FIG. 1b, the fibrous nature of the material is completely gone and the material has been restructured to be highly amorphous. This is further illustrated by the X-ray spectra of the regenerated material illustrated in FIG. 2 because the X-ray diffraction signals from the crystalline regions of spruce sawdust have disappeared after the dissolution-regeneration process. In FIG. 2, peak (a) is the diffraction peak of untreated spruce sawdust, peak (b) is the diffraction peak of spruce sawdust after being regenerated from solution in AminCl using water as the nonsolvent, and peak (c) is the diffraction peak of 8% by weight spruce sawdust dissolved in BmimCl. The Examples provided herein also illustrate the ability to regenerate previously solubilized (optionally derivatized) lignocellulosic materials.

### Derivatization of Lignocellulosic Material and Formation of Composites

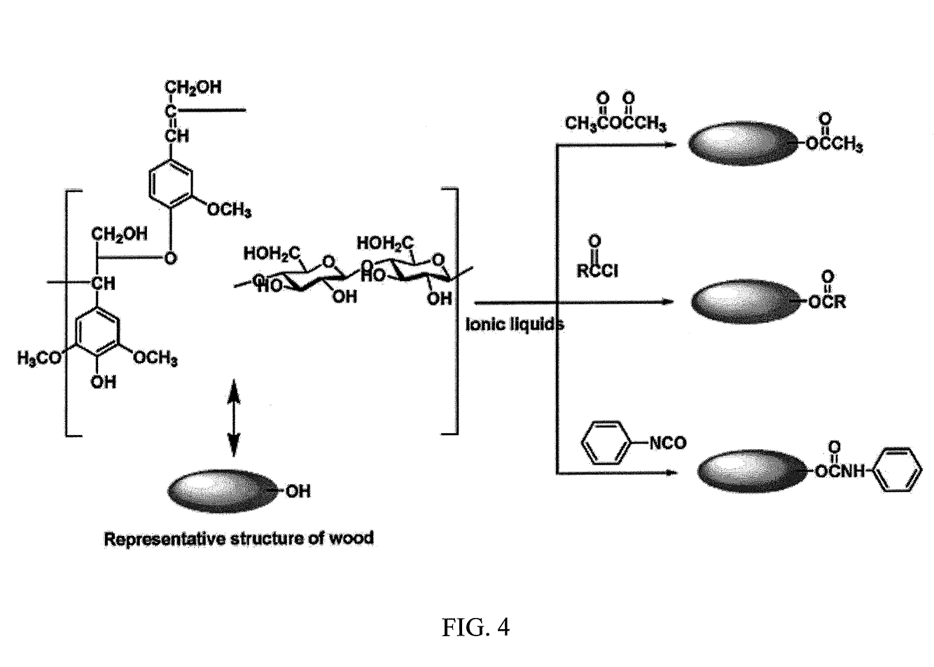

To improve compatibility of solvated lignocellulosics with various materials useful for forming composite materials, particularly nonpolar thermoplastics, it can be beneficial to make various chemical modifications to the solvated lignocellulosics. This can particularly be the case when using wood as the lignocellulosic material. A flowchart for one embodiment of the invention that includes chemical modification of wood in the preparation of composite materials is provided in FIG. 3.

The large polarity difference between lignocellulosic materials and non-polar thermoplastics (e.g., polyethylene, polypropylene, polystyrene) has prevented lignocellulosic materials from performing effectively as reinforcing agents or even fillers within traditional thermoplastics. It has been found according to the present invention, however, that chemical modification of lignocellulosic material can make it possible to effectively incorporate lignocellulosic materials into polymeric schemes thereby forming bioplastics (i.e., the result of the combination of synthetic polymers and chemically derivatized natural polymers—lignocellulosics).

The use of ionic liquids as the solvent for lignocellulosics according to the present invention is particularly advantageous since a wide range of chemical reactions can be performed in ionic liquids with significant alterations in the reaction rates and the stabilization of the various transition state complexes. Moreover, as previously noted, the ability of the ionic liquids to achieve complete dissolution of lignocellulosic materials places the materials in a state that is more readily subject to chemical modification. For example, as illustrated in FIG. 2, the crystallinity of the cellulose in the wood can be eliminated with ionic liquid dissolution. Such a transformation is particularly beneficial to allow a greater accessibility to reactive sites for chemical modification (i.e., derivatization to form modified bulk chemical or surface modified chemical).

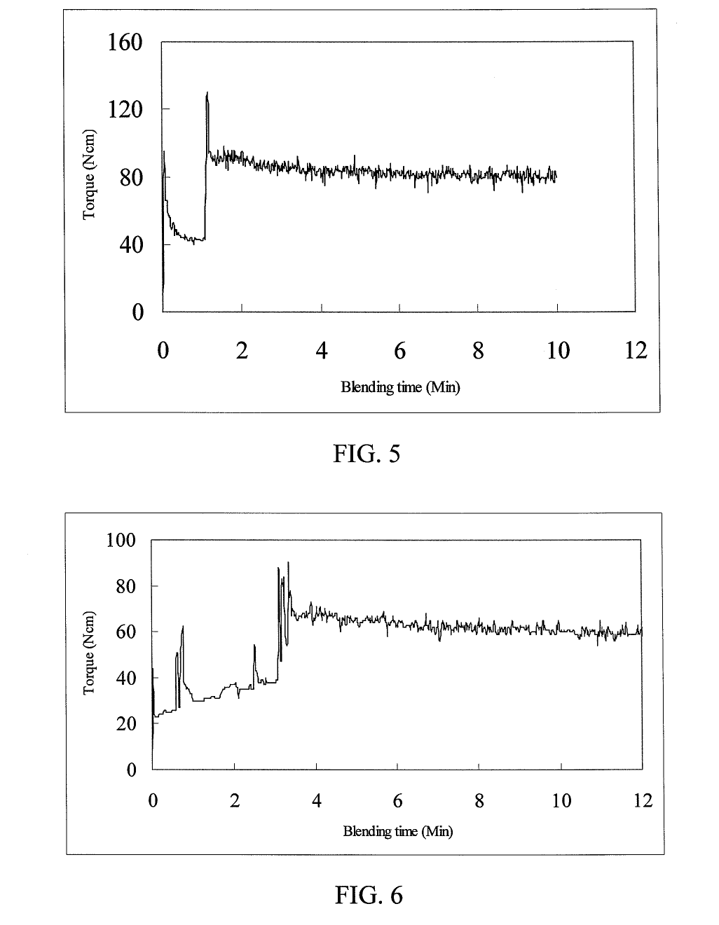

This is further illustrated in FIG. 4, which illustrates a reaction scheme for the chemical modification of wood dissolved in ionic liquid through acylation and carbanilation. In FIG. 4, the complex lignocellulosic nature of wood is illustrated by a representative structure that is dissolved in ionic liquid and modified through acylation (where R is an organic moiety) or carbanilation. Of course, these are only representative of the types of modifications that can be made according to the invention.

As one example of the invention, wood-based lignocellulosic materials that are highly substituted (e.g., alkylated, benzoylated, and carbanilated) can be produced upon dissolution of the wood in ionic liquids under conditions as described herein. Beneficially, derivatized lignocellulosic materials according to the invention show thermal properties characteristic of thermoplastic behavior. Accordingly, functionalization of hydroxyl groups present in lignocellulosic materials, such as wood, to hydrophobic functionalities can increase the overall interfacial miscibility with synthetic polymers. This replacement of hydroxyl groups with other functional groups is particularly illustrated in FIG. 4, as described above.

In one embodiment, wood can be essentially completely acetylated by subjecting fully dissolved wood in AmimCl to an incremental addition of a 1:1 mixture of acetic anhydride/pyridine. An IR spectral analysis of spruce wood sawdust and an acetylated sample regenerated from AmimCl confirmed the change. In particular, the hydroxyl IR stretch band located at 3500 cm⁻¹ on the native spruce wood sample was completely absent in the acetylated sample. Moreover, the acetylated sample included a strong —C═O stretching band at 1750 cm⁻¹ that was not present in the native spruce wood sample and which exemplified the complete acetylation. The rigid and compact nature of wood is known to be attributed to an intricate hydrogen-bonded network that precludes its solubility in common molecular solvents. Thus, the demonstration of complete acetylation is particularly surprising. The complete derivatization of all of the hydroxyl functionalities also emphasizes that the obtained wood solutions are true solutions, and they are not simply gels or larger aggregates.

The ability to form wood derivatives is further illustrated in the Examples. In particular, examples are provided illustrating the ability to modify wood through dissolution in ionic liquid and modification via addition of an acetyl moiety (acetylation), addition of an isocyanate moiety (carbanilation), addition of a benzoyl moiety (benzoylation), and addition a lauroyl moiety (lauroylation). It is possible according to the invention, though, to modify lignocellulosic materials through addition of a number of chemical additives. In certain embodiments, solvated lignocellulosics can be modified through addition of any chemical moiety capable of forming a modified lignocellulosic material having reactive sites useful for later reaction with various polymers to form composite materials according to the invention. In particular embodiments, moieties for use in lignocellulosic derivatization include any organic functional moiety, particularly any group known to be useful in forming polymeric materials. Beneficially, the organic moiety can be polar or non-polar in nature. In certain embodiments, it is especially useful for the derivatizing agent to comprise moieties including a carboxyl group and that are thus capable of reacting with the hydroxyl groups on the lignocellulosic material to form an ester linkage such that the derivatized material has the structure according to Formula (21)

Lignocellulose-O—C(O)—R (21)

where R is an organic moiety, which can be polar or non-polar. Accordingly, the derivatizing moiety useful to derivatize a lignocellulosic material according to the invention can include variously substituted and unsubstituted carboxylic acids, carboxylic esters, acyl halides, acyl pseudohalides, acid anhydrides, aldehydes, ketones, and carboxamides.

In further embodiments, the derivatizing agent can comprise moieties including groups capable of reacting with the lignocellulosic material to form a variety of lignocellulosic ether derivatives. In specific embodiments, useful moieties comprise those including a halogen leaving group that are thus capable of reacting with the alkali earth metal salt of the ionized hydroxyl groups on the lignocellulosic material to form an ether linkage such that the derivatized material has the structure according to Formula (22)

Lignocellulose-O—R (22)

wherein R is an organic moiety, which can be polar or non-polar. Accordingly, the derivatizing moiety useful to derivatize a lignocellulosic material according to the invention can include variously substituted and unsubstituted aliphatic halides.

The derivatized lignocellulosic material can be recovered from the ionic liquid and then combined with the composite-forming polymeric material. Recovery of the derivatized lignocellulosic material may be via the regeneration means described herein. Alternately, the composite-forming polymeric material may be added directly to the ionic liquid with the derivatized lignocellulosic material therein. Still further, the additional materials can be added to the ionic liquid along with the lignocellulosic material and be at least partially dissolved with the lignocellulosic material. The combination of the materials can be achieved through a variety of process, such as direct blending, chemical modification, in-situ polymerization, graft polymerization, or in-situ cross-linking. Preferably, additives are combined with the lignocellulosic material after dissolution thereof.

The composite material can be recovered from the ionic liquid by a variety of mechanisms. For example, the solution can be plated to form a membrane, and the ionic liquid can be washed away after membrane formation. In further embodiments, such when a cross-linked material is formed, the material can be isolated from the ionic liquid by methods, such as precipitation with a regenerating solvent. For example, water (or another polar solvent) can be added to the solution, which spontaneously causes the previously solvated material to precipitate out. The precipitate can then be recovered by known methods, such as filtration. The form and nature of the composite materials according to the invention are more fully described below.

### Recycling of the Ionic Liquid

The invention is further characterized in that the ionic liquid media can be easily recovered and reused. After removal of precipitant, the remaining ionic liquid can be recycled. Likewise, ionic liquid washed off of a membrane can be caught and recycled. In such embodiments, the recovered ionic liquid includes the regenerating solvent, which can be removed from the ionic liquid by known methods, such as evaporation. It is therefore preferable for the regenerating solvent to be a solvent with a boiling point that is less than the boiling point of water (e.g., alcohols). Preferably suitable drying methods, such as the use of hygroscopic materials (e.g., anhydrous Na₂SO₄), are also employed to ensure the ionic liquid to be recovered is substantially free of water or other regenerating solvent.

The recovered ionic liquid can then be reused for multiple future dissolution steps. For example, the steps of dissolving the lignocellulosic material in the ionic liquid, removing precipitants, and recovering the ionic liquid can be described as encompassing a single cycle. In certain embodiments, ionic liquids used according to the present invention can be recovered for use in multiple cycles. Preferably, an ionic liquid can be recovered and used in at least 2 cycles, at least 3 cycles, at least 4 cycles, at least 5 cycles, at least 6 cycles, at least 7 cycles, at least 8 cycles, at least 9 cycles, or at least 10 cycles. This provides for great cost savings, as well as being environmentally responsible.

It has surprisingly been discovered that recycled ionic liquid according to the present invention shows evidence of fractionation during dissolution of the ionic liquid. In particular, recycling and reusing the ionic liquid in multiple dissolution cycles can lead to enrichment of the ionic liquid with hemicelluloses. For example, in one evaluation, the lignin content of regenerated eucalyptus wood was shown to increase with the use of recycled ionic liquid. Specifically, an ionic liquid was obtained and used for multiple cycles in the dissolution of eucalyptus wood, which is known to have a total lignin content of about 20%. The eucalyptus wood sample was dissolved in the ionic liquid and regenerated, such as described above. After the first cycle, the regenerated eucalyptus wood comprises 24% acid insoluble lignin and 7.2% acid soluble lignin for a total lignin content of 31.2%. The recycled ionic liquid was used in a further cycles to dissolve a sample of eucalyptus wood, which was then regenerated and evaluated for lignin content. The results of the evaluation are shown below in Table 2.

TABLE 2

| | Acid-in- | Acid- | | |
|---|---|---|---|---|
| | soluble | soluble | Total | |
| Cycle | lignin | lignin | Lignin | Note |
| 1 | 24% | 7.2% | 31.2 | Regenerated wood after 1^{st} cycle |
| 2 | 30% | 7.8% | 37.8 | Regenerated wood after 2^{nd} cycle |
| 3 | 29% | 6.8% | 35.8 | Regenerated wood after 3^{rd} cycle |
| 4 | 28% | 6.9% | 34.9 | Regenerated wood after 4^{th} cycle |
| 5 | 4.9% | 3.4% | 8.3 | Material still dissolved in ionic liquid |

As seen in Table 2, after each cycle, the regenerated wood had a higher total lignin content than the content of native eucalyptus wood, which indicates that the regenerated wood has a reduced carbohydrate content. After cycle five, the material dissolved in the ionic liquid was precipitated out. Upon evaluation, the isolated material was shown to have a total lignin content of 8.3%. This low lignin content indicates that the recycled ionic liquid is enriched in carbohydrate content (e.g., hemicelluloses). Detailed sugar analyses of this fraction were consistent with a xylan and mannan rich biopolymer as anticipated by the presence of glucuronoxylans and glucomanans in such species.

Accordingly, recycling of the ionic liquid according to the invention can include steps to purify the ionic liquid of the entrained hemicelluloses. For example, the recycled ionic liquid can be combined with a material that is a non-solvent for hemicelluloses (e.g., acetonitrile or tetrahydrofuran). This allows for the hemicelluloses to be precipitated in the non-solvents. Accordingly, the recycled ionic liquid is purified of the fractionated hemicelluloses, which are recovered. Thus, the invention provides a method for isolating hemicelluloses from lignocellulosic materials, particularly woods. The precipitated hemicelluloses can be separated from the ionic liquid by methods recognized as suitable for such separations, and the purified, recycled ionic liquid can be re-used for dissolution of further lignocellulosic materials.

### Composite Materials

The composite materials of the invention can be formed by conventional processes using the solvated, derivatized lignocellulosics, the composite-forming additive, and optional further polymeric or other additives. The invention is particularly advantageous in that the final product can be prepared directly from the solvated lignocellulosics without the need for intervening steps or pretreatments prior to the dissolution in the ionic liquid. Rather, lignocellulosic materials can be homogeneously converted to form fibrous materials, biodegradable membranes, and other moldable solids directly.

The composite materials are advantageous in that they can be formed from a variety of materials in a variety of methods, particular composite parameters being selected at the time of formation. For example, the lignocellulosic material can be blended with other biopolymers, such as silk, wool, chitin, chitosan, elastin, collagen, keratin, polyhydroxyalkanoate, DNA protein, and the like, and such blending can be carried out directly in a single batch.

The invention is further advantageous in that the solvated lignocellulosics can be blended with polar synthetic polymers that can be dissolved by ionic liquids. Again, such blending can be carried out directly in a single batch. Alternately, such synthetic polymers can be added with a selected co-solvent. In addition to the above, the solvated lignocellulosics can be blended with polar synthetic polymers that cannot be dissolved by ionic liquids. For example, the solvated lignocellulosic can be prepared as described herein and precipitated with a regenerating solvent to form a regenerated wood powder material. This material can then be blended with the polymers (such as by extrusion), particularly with polymers containing atoms capable of forming hydrogen bonds with the hydroxyl groups of the lignocellulosic matrix.

The solvated lignocellulosic materials of the invention can also be blended with non-polar synthetic polymers. Preferably, the lignocellulosic is first solvated in the ionic liquid and then modified to increase the thermoplastic properties of the wood. The synthetic polymer can then be co-extruded with the lignocellulosic material.

As previously pointed out, lignocellulosics prepared according to the invention and isolated from the ionic liquid can be mixed with a variety of synthetic high tonnage or specialty polymers and subsequently melt extruded with minimal phase separation concerns. The versatility offered by the ionic liquids arises from the ability to prepare the lignocellulosic derivatives with near 100% substitution. This offers wood or lignin specific compatibilization characteristics for melt blending, melt compounding, or solution blending the lignocellulosic with specific synthetic polymers. For example, by reacting wood with aliphatic acid chlorides, aliphatic chains are introduced throughout the wood structure making the new material compatible with polyethylene, polypropylene, and a variety of other aliphatic polymers, particularly polyesters.

The composite materials of the invention can be provided in a variety of forms. For example, the solvated lignocellulosic material may be regenerated and dried to form a powder, which can be combined with a polymer to form a liquid melt. The liquid melt could be immediately used to form a fiber, membrane, or other product. Optionally, the liquid melt could be solidified and formed into bulk solid polymer that can be later melted at the point of use.

Multiple examples of derivatization and composite material formation using lignocellulosic materials are provided in the Experimental section below. To more fully describe the invention, particularly in terms of the unique compatibility of derivatized wood with synthetic polymers, a particular evaluation is provided. This evaluation illustrates the ability according to the invention to start with native lignocellulosic material (in this case, wood), dissolve the material in an ionic liquid, derivatize the solvated material, and combine the material with a polymeric additive to form a composite material wherein the individual components are highly miscible and wherein the composite material can be processed into a variety of useful forms.

The lignocellulosic material used in the evaluation was spruce (southern pine) thermomechanical pulp (TMP), which is available commercially. The wood sample was extracted in a Soxhlet extractor with acetone for 48 hours and then kept in a vacuum oven for at least 48 hours at 40° C. prior to use.

Benzoylated spruce was prepared by first dissolving the pine TMP in BmimCl ionic liquid to form a 4% w/w solution. To 6 grams of the wood/ionic liquid solution was added pyridine (0.55 ml, 7.55 mmol) followed by the incremental addition of benzoyl chloride (0.88 ml, 7.55 mmol, based on 2 mol mol⁻¹ hydroxyl groups in wood). This solution was initially stirred at room temperature for 10 minutes and then kept at 70° C. for 2 hours. The derivative was isolated by re-precipitation of the cooled solution into methanol (100 ml), followed by water (100 ml) under rapid agitation. The solid product (obtained after filtration and washing with methanol:water (1:1 mixture) and vacuum drying at 40° C. for 18 hours) was of a fluffy powdery texture (0.58 g). The weight percentage gain (WPG) was approximately 143% (theoretical WPG=164%).

Lauroylated spruce was prepared by forming an identical 4% w/w wood/ionic liquid solution as described above followed by the incremental addition of lauroyl chloride (1.74 ml, 7.55 mmol, based on 2 mol mol⁻¹ hydroxyl groups in wood). This solution was initially stirred at room temperature for 10 minutes and was then kept at 70° C. for 2 hours. The product was precipitated from the solution during the reaction due to the low solubility of the long aliphatic chains being added. Isolation of the derivative was carried out by precipitation of the cooled solution into methanol (200 ml) under rapid agitation. The solid product was obtained after filtration and washing with methanol. The product was finally vacuum dried at 40° C. for 18 hours being of a fluffy powdery texture (0.79 g)−WPG=229% (theoretical WPG=283%, calculated on the basis of 15.57 mmol/g hydroxyl groups in spruce TMP).

The benzoylated spruce was combined with polystyrene, and the lauroylated spruce was combined with polypropylene to form composite materials (i.e., benzoylated spruce/polystyrene composites and lauroylated spruce/polypropylene composites). The polystyrene (number average molecular weight 140,000) and isotactic polypropylene (number average molecular weight 67,000) were obtained commercially and used as supplied.

Plastic composite materials were prepared using a MiniLab Rheomex CTW5 twin-screw extruder (available from ThermoHaake) operated at a rotation speed of 120-150 rpm. To form the composites, the powdered benzoylated spruce or powdered lauroylated spruce was combined with the polystyrene or polypropylene and physically mixed external to the extruded. The combined materials were then introduced in the hopper of the extruder. After a mixing period of several minutes (and once torque curves were recorded and stabilized), the orifice of the extruder was opened and a filament was pulled. The extrusion temperature was set at 221° C. for all samples. The formed composite filament was collected around a continuously rotating spool. A variety of compositions were examined using different concentrations of wood (derivatized or non-derivatized) mixed with the respective polymeric material.

The successful formation of the extruded fibers clearly illustrates the ability according to the invention to prepare composite materials using derivatized wood that has been solubilized in ionic liquid. The further illustrate the beneficial aspects of the invention, however, various modes of analysis of the formed composite fiber were carried out. For example, the analysis of the development of the torque curves was carried out because of its ability to monitoring the interfacial adhesion and compatibility of the two components. This information is also extremely useful in verifying and probing the effects of the chemical modification of the wood on its melt flow and melt mixing characteristics with the synthetic polymers examined.

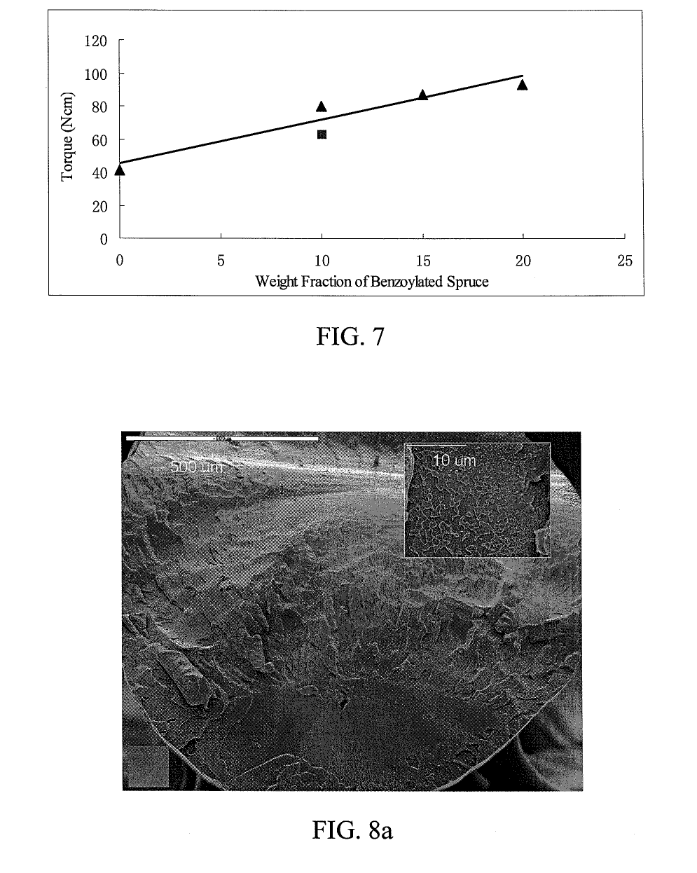

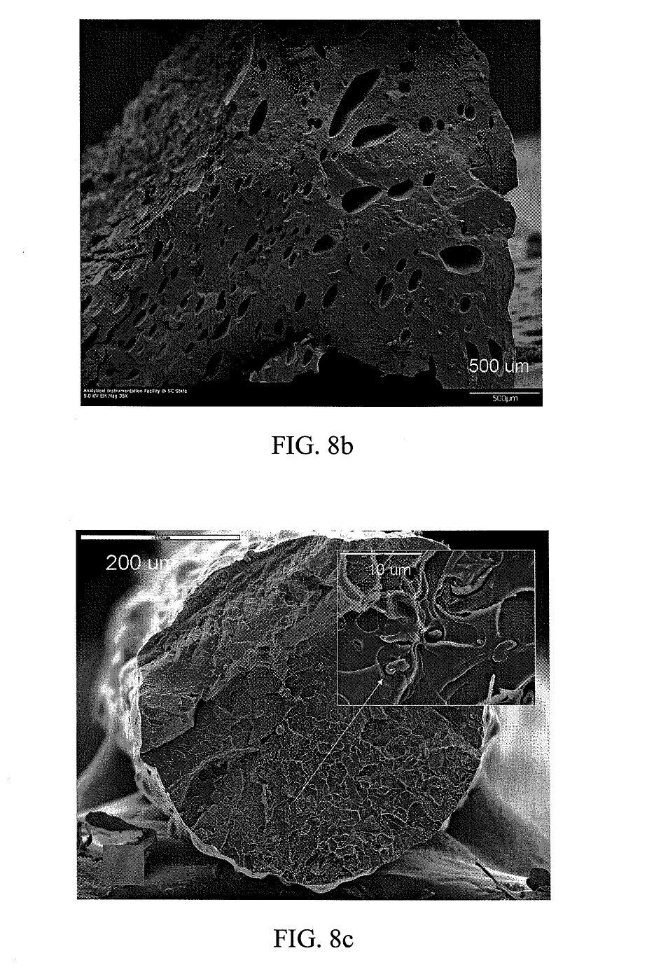

A torque vs. mixing time curve for the blending of 10% by weight benzoylated spruce TMP with polystyrene (221° C.) is shown in FIG. 5. As a comparison, a torque vs. mixing curve for the blending of 10% by weight (non-derivatized) spruce TMP with polystyrene (221° C.) is shown in FIG. 6. It is readily apparent that the data of FIG. 5 obtained for the polystyrene/benzoylated wood pair is significantly smoother than its control counterpart of FIG. 6 obtained for the polystyrene/non-functionalized TMP fibers pair.

More particularly, FIG. 5 shows that the polystyrene melted fast (Tg about 100° C.) providing a rather smooth torque response with the torque value stabilizing at around 40 Ncm within approximately one minute of mixing. The melting of the benzoylated TMP then followed (Tg about 136° C.) giving rise to a sharp increase in torque, rapidly stabilizing at about 80 Ncm. The torque curve of the polystyrene/non-functionalized TMP fibers pair was significantly different. The melting of polystyrene provided a significantly more noisy torque curve, (without the clear plateau obtained in FIG. 5 at 40 Ncm) since the TMP fibers created a rather inhomogeneous local environment. After about 3.5 minutes of mixing, the torque was increased most likely due to the TMP fibers becoming coated with the melted polystyrene. The new torque value started to stabilize after about 4 minutes as opposed to 1.6 minutes in the case where benzoylated spruce was used. A comparison of the final, stabilized torque values for the two pairs is also indicative of better melt stability and compatibility between the benzoylated wood and the polystyrene (as opposed to the non-derivatized wood). This is because polymer melts between two miscible polymers should give rise to higher torque values in the mini extruder as opposed to polymer melts that contain particles or fibers that create voids within the melt structure. This is the case as illustrated in FIG. 5 and FIG. 6 where the stabilized torque value for the benzoylated wood/polystyrene pair (FIG. 5) was about 80 Ncm as opposed to a value of about 60 Ncm obtained for the (non-derivatized) TMP/polystyrene pair (FIG. 6).

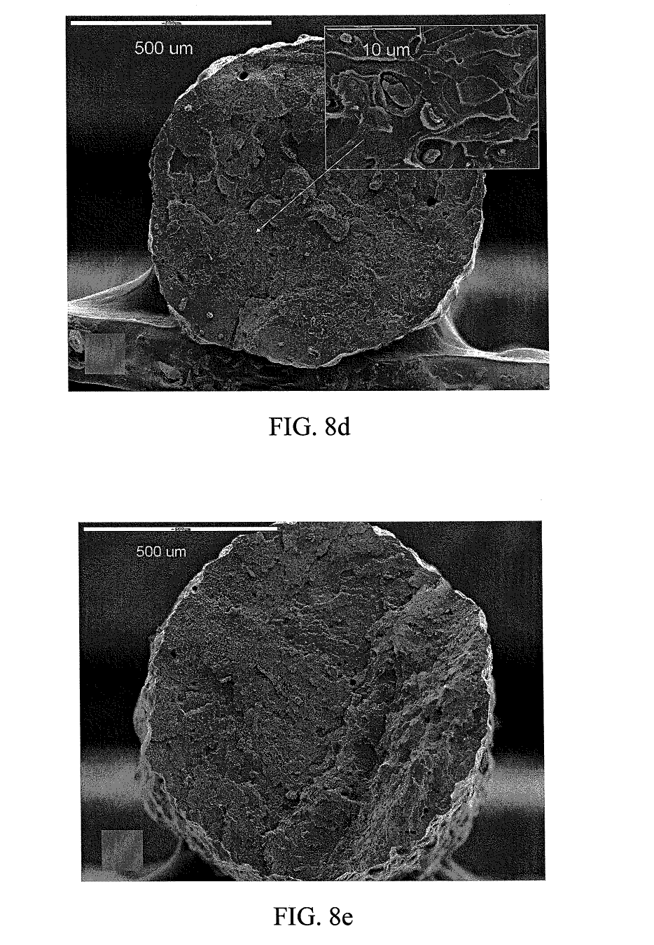

Therefore, it is clear that the melted benzoylated spruce provided a melt environment that resulted in higher torque values when compared to pure polystyrene. This indicates that increasing the loading of benzoylated spruce wood within a polystyrene melt would increase the resulting torque values. In fact, as illustrated in FIG. 7, there was a nearly linear response of the torque versus the weight fraction of benzoylated spruce in the melt with torque values increasing from 41 Ncm to 93 Ncm at 20% by weight loading after 8 minutes mixing time in each case. In FIG. 7, data points for polystyrene/benzoylated spruce composites are denoted with a triangle, and the data point for polystyrene/(non-derivatized) spruce TMP is denoted with a square.

Composite materials prepared according to the invention can be evaluated by conventional methods to determine the various properties. For example, SEM micrographs of the surfaces of blended membranes according to the invention (such as exemplified in Example 3) display a homogeneous structure, which exhibits a good degree of miscibility of the components (which supports the results of the torque curve analyses described above). The membranes of the invention do not exhibit a residual fiber structure, which further supports the complete dissolution of the wood-based lignocellulosic materials in ionic liquids.

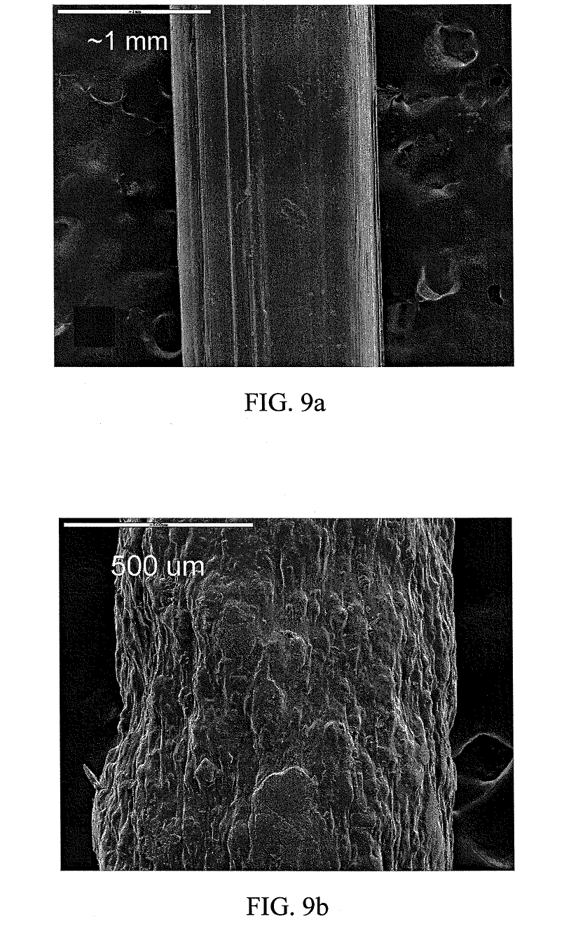

The ability according to the invention to provide effective combinations of wood and non-polar polymers can also be illustrated by morphological studies of the formed composite materials. Examination of the fractured surfaces (a cut cross-section) of the composites by scanning electron microscopy makes it possible to evaluate how modifications affect the morphology of the composite and interfacial region between the synthetic polymeric matrix and wood derivatives. A serial of comparative SEM pictures of fractured surfaces of composites formed of benzoylated spruce wood and polystyrene are provided in FIG. 8a, FIG. 8b, FIG. 8c, and FIG. 8d.

As illustrated in FIG. 8a, pure polystyrene shows a very homogenous morphology fractured surface. As illustrated in FIG. 8b, with the addition of 10% spruce TMP (non-derivatized), the fiber surface is completely free of polymeric matrix, and a relatively strong fiber pullout is observed. This indicates poor adhesion between the polystyrene phase and the spruce TMP phase in FIG. 8b, which is likely due to the bad dispersion of hydrophilic spruce TMP in non-polar polystyrene. As seen in FIG. 8c, FIG. 8d, and FIG. 8e, which illustrate embodiments of composites of polystyrene and benzoylated spruce TMP, although there still remains very small observable residual fiber-like regions, the increased interface miscibility is observed because of the increased Van der Waals interaction among the aromatic functionalities both in benzoylated spruce and polystyrene.

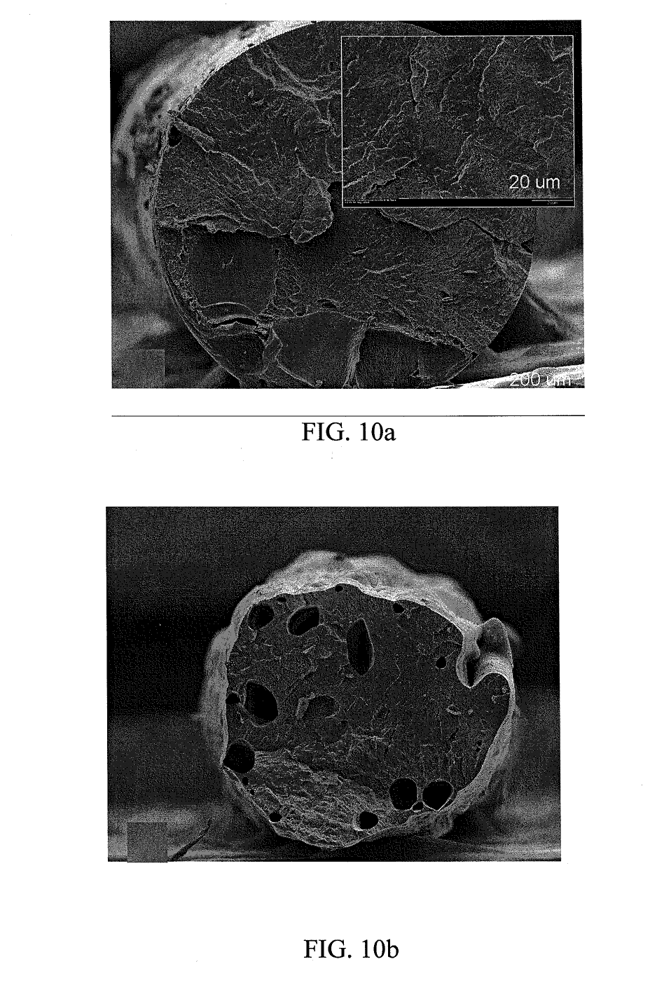

Evaluation of fiber surface also reveals the structural changes in a polystyrene fiber brought about by incorporation of derivatized lignocellulosic material. As seen in FIG. 9a, a polystyrene fiber has a noticeably smooth fiber surface. As seen in FIG. 9b, combination of benzoylated spruce and polystyrene (20% benzoylated spruce/polystyrene composite) results in a rough fiber surface; however, the symmetrical roughness of the filament again provides evidence that benzoylated spruce according to the invention achieves a very good dispersion throughout the polystyrene.

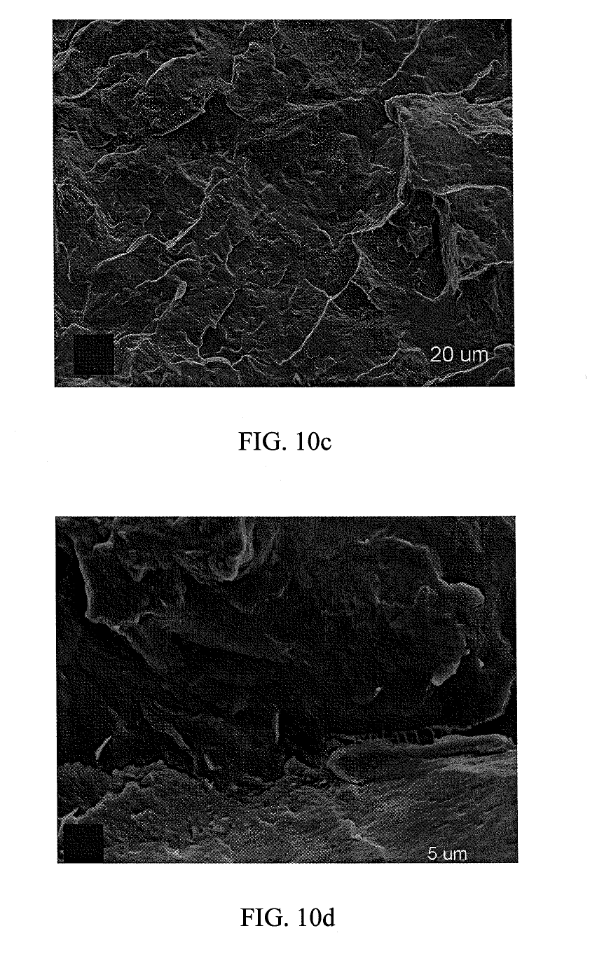

Similar results can also be achieved with composites of lauroylated spruce TMP and polypropylene. For comparative purposes, FIG. 10a provides a SEM micrograph of a cross-sectional fractured surface of a fiber prepared using a polypropylene homopolymer. As seen in FIG. 10b, though, the addition of non-derivatized spruce TMP to polypropylene results in a fiber wherein the homogeneous morphology of the polypropylene has been changed to a foamed state. This is overcome, though, through use of derivatized spruce TMP according to the invention. For example, FIG. 10c and FIG. 10d show SEM micrographs of cross-sections from fibers formed 5% by weight lauroylated spruce TMP/polypropylene composite and 15% by weight lauroylated spruce TMP/polypropylene composite, respectively. The addition of the lauroylated spruce TMP clearly showed improved miscibility between the polypropylene and the spruce TMP.

### EXPERIMENTAL

The present invention will now be described with specific reference to various examples. The following examples are not intended to be limiting of the invention and are rather provided as exemplary embodiments.

### Example 1

### Preparation of Spruce Membrane Materials

A solution of 8% by wt. Spruce wood thermomechanical pulp (TMP) in ionic liquid (1-butyl-3-methyl imidazolium chloride) was prepared by combining the components and mechanically stirring at 110° C. over an 8 hour time period. The obtained solution was kept under vacuum in order to remove air bubbles. Films were produced using coating rods forming a uniform membrane of Spruce wood/ionic liquid on a glass plate. Once the films were produced the ionic liquid was gently removed using water flow. After washing the films with water, they were allowed to dry in a vacuum oven at room temperature. As the water was evaporated the films began to shrink forming a hardened uniform membrane.

### Example 2

### Pine TMP/Tonic Liquid Composite Material

A solution of 5% by wt. Pine TMP was prepared in an ionic liquid formed using 1-allyl-3-methyl imidazolium chloride and formed into a film according to the method of Example 1. After the Pine/ionic liquids film was cast on the glass plate the plate was immersed into ethanol for 5 minutes and the ionic liquid present on the surface of the membrane was washed away with water.

### Example 3

### Spruce TMP/PVA Blend

A solution of 5% by wt. spruce TMP with polyvinyl alcohol (PVA) (Spruce TMP/PVA=20/80, 40/60, 60/40; PVA MW=15,000) was prepared using 1-butyl-3-methyl imidazolium chloride ionic liquid. Dissolution was achieved with the addition of Spruce and PVA in suitable proportions at 130° C. over a period of 8 hours with stirring. The blended solutions were allowed to cool and coagulate as membranes using methanol. Then the films were placed in a methanol bath and allowed to soak for 24 h, in order to allow for a maximum amount of ionic liquid to diffuse out of the blended composite. The composites were dried in an oven set at 45° C. for 24 h.

### Example 4

### Spruce TMP/PEO Blend

A solution of 5% by wt. spruce TMP with polyethylene oxide (PEO) (Spruce TMP/PEO=20/80, 40/60, 60/40; PEO MW=15,000) was prepared using 1-butyl-3-methyl imidazolium chloride ionic liquid. Dissolution was achieved with the addition of Spruce and PEO in suitable proportions at 130° C. over a period of 8 hours. The blended solutions were allowed to cool and membranes were cast. The films were then placed in a methanol bath and allowed to soak for 24 h, in order to allow for maximum amount of ionic liquid to diffuse out of the blended composite. The composites were dried in an oven set at 45° C. for 24 h.

### Example 5

### 1,4-Phenylene Diisocyanate Cross-Linked Spruce Composites

A solution of 5% by wt. Spruce was prepared using 1-butyl-3-methyl imidazolium chloride ionic liquid with mechanical stirring at 110° C. over 8 hours. Next, 25% by wt. (based on the weight of spruce) of 1,4-phenylene diisocyanate was added into the solution directly with continuous stirring for 1 hour at 60° C. Methanol was added into the solution to quench the crossing linking reaction, and the diisocyanate crosslinked spruce was precipitated in water under rapid stirring. The resulting cross-linked lignocellulosic material was swellable, but insoluble, in a variety of aqueous and organic solvents, including aqueous alkali materials, dimethylsulfoxide, tetrahydrofuran, and dimethyl formamide.

### Example 6

### Hydrogels Formed with Glycidyl Methacrylate Cross-Linking

Solutions of 5% by wt. Spruce, cellulose, or lignin were prepared using 1-butyl-3-methyl imidazolium chloride ionic liquid with mechanical stirring at 110° C. over a period of several hours. The temperature was reduced to 45° C., and glycidyl methacrylate was added to each solution. To the wood solution, 40.6 mmoles (plus 5% excess) and a catalytic amount of dimethylamino pyridine were added. To the cellulose solution, 3 mole equivalents of glycidyl methacrylate were added. For the lignin solution, the actual amount of the derivatizing reagent was independently calculated after the lignin was subject to OH group determination using ³¹P NMR. The derivatization reaction was then allowed to proceed for 48 hours at 60° C. Methanol was added into the solution to quench the cross-linking reaction, and the epoxide cross-linked lignocellulosic materials were precipitated in water under rapid stirring.

The resulting crosslinked lignocellulosic hydrogel material was highly swollen in aqueous media. The cellulose hydrogels were particularly transparent materials and all possessed tunable swelling characteristics depending on the pH of the aqueous environment. All hydrogels were insoluble in a variety of aqueous and organic solvents including dilute aqueous alkalis, dimethylsulfoxide, tetrahydrofuran, and dimethyl formamide.

### Example 7

### Aromatic Urethane Derivatives of Spruce in Ionic Liquid

A solution of 5% by wt. Spruce was prepared using 1-butyl-3-methyl imidazolium chloride ionic liquid with mechanical stirring at 110° C. over 8 hours. An excess (2.5 equivalents to the molar amount of hydroxyl group in the wood, calculated on the basis of 40.6 mmoles) of phenyl isocyanate was added into the solution, and stirring was continued at 80° C. Methanol was added into the solution to stop the reaction, and the carbanilated spruce derivative material was precipitated using 200 ml methanol, followed by washing with methanol and drying under vacuum at 40° C.

### Example 8

### Phthalated Spruce Derivative

A solution of 5% by wt. Spruce was prepared using 1-butyl-3-methyl imidazolium chloride ionic liquid with mechanical stirring at 110° C. over 8 hours. An excess (2.5 equivalents to the molar amount of hydroxyl group in the wood) of phthalic anhydride was added into the solution directly, and stirring continued at 80° C. Methanol was added into the solution to stop the reaction, and the phthalated spruce derivative material was precipitated using 200 ml methanol, followed by washing with methanol and drying under vacuum at 40° C.

### Example 9

### Benzoyl Ester Derivative of Spruce Wood

Pyridine (0.55 ml, 7.55 mmol) was added to a wood solution (6 g, containing, 4% w/w Spruce in BmimCl) followed by the incremental addition of benzoyl chloride (0.88 ml, 7.55 mmol, based on 2 mol mol⁻¹ hydroxyl groups in wood). This solution was initially stirred at room temperature for 10 mins and then kept at 70° C. for 2 hours. The derivative was isolated by reprecipitation of the cooled solution into methanol (100 ml), followed by water (100 ml) under rapid agitation. The solid product, obtained after filtration and washing with methanol:water (1:1 mixture) and vacuum drying at 40° C. for 18 hrs, was of a fluffy powdery texture (0.58 g), weight percentage gain (WPG)=143% (theoretical WPG 164%).

WPG values were obtained in order to quantitatively follow the modification efficiency of the wood. The WPG values were calculated according to the formula

WPG(%)=100×(W_{mod}−W_{unmod})/W_{unmod}

where W_{unmod} is the initial oven-dried mass of the lignocellulosic sample before chemical modification and W_{mod} is the oven-dried mass of the modified material. There are 6.68 mmol/g of aliphatic hydroxyl groups and 1.37 mmol/g of phenolics hydroxyl groups in Norway spruce enzymatic mild acidolysis lignin (EMAL). Independent measurements for this wood showed that it contained 73.4% carbohydrates and 26.6% lignin. As such, one may calculate an approximate value for the total hydroxyl group content in this sample of the examined spruce TMP (15.7 mmol/g). From these data, one may then calculate a theoretical WPG value for each modification reaction performed.

### Example 10

### Mechanical Properties of Wood Films

The tensile properties of various specimens were tested. Each specimen measured 5 mm×40 mm and was measured with a crosshead speed of 15 mm/min using an Instron tensile tester under ambient conditions (21° C. and 65% relative humidity. The test results are provided in Table 3 (all results being the average of 5 test runs).

TABLE 3

| | Tensile | Tensile | Elongation |
|---|---|---|---|
| | Modulus | Strength | at Break |
| Sample | (GPa) | (MPa) | (%) |
| Spruce TMP and | 2.54 | 33.76 | 2.4 |
| polyvinyl alcohol | | | |
| Spruce TMP | 1.57 | 11.53 | 2.9 |
| Spruce and polymethyl | 0.72 | 5.03 | 1.8 |
| methacrylate (1:1) | | | |

### Example 11

### Dissolution of Lignin in 1-Butyl-3-Methyl Imidazolium Chloride

Ionic liquid (10 g) was charged into a 50 ml dried flask under inert atmosphere (argon). The temperature of the dissolution process was controlled using an oil bath at 120° C. Dried lignin (Kraft pine, Kraft hardwood, or lignosulfonate) was added into the ionic liquid to form a 10% w/w solution prepared over two hours under mechanical stirring. The dissolution of lignin in ionic liquid resulted in the formation of a viscous, brown-black solution.

### Example 12

### Preparation of Hardwood Lignin/Pan Membrane Materials

A solution of 8% by wt. hardwood lignin/polyacrylonitrile (PAN) (3/2 weight fraction) in ionic liquid (1-butyl-3-methyl imidazolium chloride) was prepared by combining the components and mechanically stirring at 120° C. over a 2 h time period. The obtained solution was kept under vacuum in order to remove air bubbles. Films were produced using coating rods forming a uniform membrane on a glass plate. Once the films were produced the ionic liquid was gently removed using water flow. After washing the films with water, they were allowed to dry in a vacuum oven at room temperature.

### Example 13

### Benzoyl Ester Derivative of Hardwood Lignin

A solution of 10% by wt. hardwood lignin was prepared using 1-butyl-3-methyl imidazolium chloride ionic liquid with mechanical stirring at 120° C. over 2 hours. Various excess ratios (1.5, 2.0, 2.5, and 3 equivalents to the molar amount of hydroxyl groups present in the wood) of benzoyl chloride and pyridine were added into the solution directly, and stirring continued at 80° C. Methanol was added into the solution to stop the reaction, and the derivatives were precipitated using 200 ml methanol, followed by washing with methanol and drying under vacuum at 40° C.

### Example 14

### Preparation of Lauroylated Spruce

Pyridine (0.55 ml, 7.55 mmol) was added to a wood solution (6 g, containing, 4% w/w Spruce in BmimCl solution) followed by the incremental addition of lauroyl chloride (1.74 ml, 7.55 mmol, based on 2 mol mol⁻¹ hydroxyl groups in wood). This solution was initially stirred at room temperature for 10 mins and was then kept at 70° C. for 2 hours. The product was precipitated from the solution during the reaction, due to the low solubility of the long aliphatic chains being added. Isolation of the derivative was carried out by precipitation of the cooled solution into methanol (200 ml) under rapid agitation. The solid product was obtained after filtration and washing with methanol. The product was finally vacuum dried at 40° C. for 18 hrs being of a fluffy powdery texture (0.79 g), WPG=229% (theoretical WPG=283%, calculated on the basis of 15.57 mmol/g hydroxyl groups in Spruce TMP).

### Example 15

### Preparation of Carbanilated Spruce

Phenyl isocyanate (0.82 mL, 7.55 mmol, 2 mol per mol hydroxyl groups in wood) was carefully added into a wood solution (6 g, 4% w/w Spruce in BmimCl), stirred at room temperature for 10 min, and kept at 70° C. for 2 hours. Product isolation was carried out by using the same method as described in Example 9. The product was obtained after filtration and washing with methanol/water (1/1, v/v mixture). The product, a white solid powder (0.58 g), was obtained after being dried in a vacuum oven set at 40° C. for 18 hours; WPG=142% (max. theoretical WPG=187%).

### Example 16

### Recycling and Purification of Ionic Liquids

The used ionic liquid from the derivatization of wood was recycled for use in further derivatization steps. The used ionic liquid contained water and methanol, which were added to precipitate and wash the derivatized product that was removed from the ionic liquid before the recycling step. To the ionic liquid solution was added an aqueous solution (20% by weight) of Na₂CO₃ until reaching a pH of about 9. Any formed precipitate was filtered, and water and methanol were removed using a rotary evaporator. Dichloromethane (20 mL) was added to the residue, and the solution was dried with anhydrous Na₂SO₄ for 2 hours. The dried material was filtered. After vacuum drying for 24 hours at 70° C., 5.4 grams of recycled ionic liquid was obtained for a 94% yield.

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A composite material comprising an ionic liquid solvated lignocellulosic material in combination with a further polymeric component.

2. The composite material according to claim 1, wherein the further polymeric component comprises a natural polymer.

3. The composite material according to claim 1, wherein the further polymeric component comprises a synthetic polymer.

4. The composite material according to claim 1, wherein the further polymeric component comprises a non-polar polymer.

5. The composite material according to claim 1, wherein the further polymeric component is selected from the group consisting of polysaccharides, polyesters, polyamides, aromatic polyamides, polyimides, polyurethanes, polysiloxanes, aromatic polymers, phenol polymers, polysulfides, polyacetals, polyolefins, halogenated polyolefins, polyethylene oxides, polyacrylates, polymethacrylates, polycarbonates, polydienes, and combinations thereof.

6. The composite material according to claim 1, wherein the solvated lignocellulosic material is a derivatized material.

7. The composite material according to claim 6, wherein the solvated lignocellulosic material is chemically derivatized through a reaction with one or more naturally occurring hydroxyl moiety present in the lignocellulosic material to add a different, derivatizing chemical moiety.

8. The composite material according to claim 7, wherein the derivatizing moiety comprises a carboxyl group that reacts with the hydroxyl moiety on the lignocellulosic material to form an ester linkage.

9. The composite material according to claim 7, wherein the derivatizing moiety comprises a halogen leaving group that reacts with the hydroxyl moiety on the lignocellulosic material to form an ether linkage.

10. The composite material according to claim 7, wherein the derivatizing moiety is selected from the group consisting of carboxylic acids, carboxylic esters, acyl halides, acyl pseudohalides, acid anhydrides, aldehydes, ketones, carboxamides, aliphatic halides, and combinations thereof.

11. The composite material according to claim 1, wherein the composite material is in the form of a liquid melt.

12. The composite material according to claim 1, wherein the composite material is in the form of a fiber or membrane.

13. The composite material according to claim 1, wherein the ionic liquid solvated lignocellulosic material comprises a wood.

14. A derivatized lignocellulosic material, comprising a lignocellulosic material that has been chemically derivatized such that one or more naturally occurring hydroxyl moiety present in the lignocellulosic material has been replaced with a different, derivatizing chemical moiety.

15. The derivatized lignocellulosic material according to claim 14, wherein the lignocellulosic material comprises an ionic liquid solvated lignocellulosic material.

16. The derivatized lignocellulosic material according to claim 14, wherein the lignocellulosic material comprises a wood.

17. The derivatized lignocellulosic material according to claim 14, wherein the derivatizing moiety comprises a carboxyl group that reacts with the hydroxyl moiety on the lignocellulosic material such that the derivatizing moiety is linked to the lignocellulosic material via an ester linkage.

18. The derivatized lignocellulosic material according to claim 14, wherein the derivatizing moiety comprises a halogen leaving group that reacts with the hydroxyl moiety on the lignocellulosic material such that the derivatizing moiety is linked to the lignocellulosic material via an ether linkage.

19. The derivatized lignocellulosic material according to claim 14, wherein the derivatizing moiety is selected from the group consisting of carboxylic acids, carboxylic esters, acyl halides, acyl pseudohalides, acid anhydrides, aldehydes, ketones, carboxamides, aliphatic halides, and combinations thereof.

20. The derivatized lignocellulosic material according to claim 14, wherein the derivatized lignocellulosic material is solubilized in an ionic liquid.

21. The derivatized lignocellulosic material according to claim 14, wherein the derivatized lignocellulosic material is a solid.

22. The derivatized lignocellulosic material according to claim 21, wherein the derivatized lignocellulosic material is a powder.

23. A method of preparing a composite material comprising dissolving a lignocellulosic material in an ionic liquid to form a solution and combining the solvated lignocellulosic material with a further polymeric component.

24. The method according to claim 23, wherein the further polymeric component comprises a natural polymer.

25. The method according to claim 23, wherein the further polymeric component comprises a synthetic polymer.

26. The method according to claim 25, wherein the further polymeric component comprises a non-polar polymer.

27. The method according to claim 25, wherein the further polymeric component is selected from the group consisting of polysaccharides, polyesters, polyamides, aromatic polyamides, polyimides, polyurethanes, polysiloxanes, aromatic polymers, phenol polymers, polysulfides, polyacetals, polyolefins, halogenated polyolefins, polyethylene oxides, polyacrylates, polymethacrylates, polycarbonates, polydienes, and combinations thereof.

28. The method according to claim 23, further comprising, prior to said combining step, derivatizing the solvated lignocellulosic material.

29. The method according to claim 28, wherein said derivatizing step comprises combining the solvated lignocellulosic material with a derivatizing chemical moiety to replace one or more naturally occurring hydroxyl moiety present in the lignocellulosic material with the different, derivatizing moiety.

30. The method according to claim 29, wherein the derivatizing moiety comprises a carboxyl group that reacts with the hydroxyl moiety on the lignocellulosic material to form an ester linkage.

31. The method according to claim 29, wherein the derivatizing moiety comprises a halogen leaving group that reacts with the hydroxyl moiety on the lignocellulosic material to form an ether linkage.

32. The method according to claim 29, wherein the derivatizing moiety is selected from the group consisting of carboxylic acids, carboxylic esters, acyl halides, acyl pseudohalides, acid anhydrides, aldehydes, ketones, carboxamides, aliphatic halides, and combinations thereof.

33. The method according to claim 23, wherein said combining step comprises melt processing or solution blending the solvated lignocellulosic material and the further polymeric component.

34. The method according to claim 23, wherein said combining step comprises adding the further polymeric component to the solution.

35. The method according to claim 23, further comprising, prior to said combining step, regenerating the solvated lignocellulosic material to form a solid, regenerated lignocellulosic material.

36. The method according to claim 35, wherein said combining step comprises mixing the regenerated lignocellulosic material with the further polymeric component to form a melt.

37. The method according to claim 36, further comprising extruding the melt to form composite fibers.

38. The method according to claim 36, further comprising molding to the melt to a desired form.

39. The method according to claim 23, wherein the ionic liquid comprises a material formed of a cation and an anion, wherein the cation is selected from the group consisting of imidazoles, pyrazoles, thiazoles, isothiazoles, azathiozoles, oxothiazoles, oxazines, oxazolines, oxazaboroles, dithiozoles, triazoles, delenozoles, oxaphospholes, pyrroles, boroles, furans, thiophenes, phospholes, pentazoles, indoles, indolines, oxazoles, isoxazoles, isotetrazoles, tetrazoles, benzofurans, dibenzofurans, benzothiophenes, dibenzothiophenes, thiadiazoles, pyridines, pyrimidines, pyrazines, pyridazines, piperazines, piperidines, morpholones, pyrans, annolines, phthalazines, quinazolines, guanidiniums, quinxalines, choline-based analogues, derivatives thereof, and combinations thereof, and wherein the anion is selected from the group consisting of halogens, phosphates, alkylphosphates, alkenylphosphates, BF₄⁻, PF₆⁻, AsF₆⁻, NO₃⁻, N(CN)₂⁻, N(SO₃CF₃)₂⁻, amino acids, substituted or unsubstituted carboranes, perchlorates, pseudohalogens, metal chloride-based Lewis acids, C₁₋₆ carboxylates, and combinations thereof.

40. The method according to claim 39, wherein the cation is selected from the group consisting of imidazoles and pyridines, and the anion is selected from the group consisting of halogens, phosphates, alkylphosphates, alkenylphosphates, and bis(trifluoromethylsulfonyl)imide.

41. The method according to claim 23, wherein the lignocellulosic material is selected from the group consisting of tobacco, corn, corn stovers, corn residues, cornhusks, sugarcane bagasse, castor oil plant, rapeseed plant, soybean plant, cereal straw, grain processing by-products, bamboo, bamboo pulp, bamboo sawdust, energy grasses, rice straw, paper sludge, waste papers, recycled paper, recycled pulp, and combinations thereof.

42. The method according to claim 41, wherein the lignocellulosic material is a wood.

43. The method according to claim 23, wherein the lignocellulosic material, prior to dissolving in the ionic liquid, is in a form selected from the group consisting of ball-milled wood powder, sawdust, thermomechanical pulp fibers, wood chips, and combinations thereof.

44. A method of preparing a derivatized lignocellulosic material comprising dissolving a lignocellulosic material in an ionic liquid to form a solution and combining the solvated lignocellulosic material with a derivatizing chemical moiety to replace one or more naturally occurring hydroxyl moiety present in the lignocellulosic material with the different, derivatizing moiety.

45. The method according to claim 44, wherein the derivatizing moiety comprises a carboxyl group that reacts with the hydroxyl moiety on the lignocellulosic material to form an ester linkage.

46. The method according to claim 44, wherein the derivatizing moiety comprises a halogen leaving group that reacts with the hydroxyl moiety on the lignocellulosic material to form an ether linkage.

47. The method according to claim 44, wherein the derivatizing moiety is selected from the group consisting of carboxylic acids, carboxylic esters, acyl halides, acyl pseudohalides, acid anhydrides, aldehydes, ketones, carboxamides, aliphatic halides, and combinations thereof.

48. The method according to claim 44, further comprising regenerating the derivatized lignocellulosic material to form a solid, regenerated derivatized lignocellulosic material.

49. The method according to claim 44, wherein the ionic liquid comprises a material formed of a cation and an anion, wherein the cation is selected from the group consisting of imidazoles, pyrazoles, thiazoles, isothiazoles, azathiozoles, oxothiazoles, oxazines, oxazolines, oxazaboroles, dithiozoles, triazoles, delenozoles, oxaphospholes, pyrroles, boroles, furans, thiophenes, phospholes, pentazoles, indoles, indolines, oxazoles, isoxazoles, isotetrazoles, tetrazoles, benzofurans, dibenzofurans, benzothiophenes, dibenzothiophenes, thiadiazoles, pyridines, pyrimidines, pyrazines, pyridazines, piperazines, piperidines, morpholones, pyrans, annolines, phthalazines, quinazolines, guanidiniums, quinxalines, choline-based analogues, derivatives thereof, and combinations thereof, and wherein the anion is selected from the group consisting of halogens, phosphates, alkylphosphates, alkenylphosphates, BF₄⁻, PF₆⁻, AsF₆⁻, NO₃⁻, N(CN)₂⁻, N(SO₃CF₃)₂⁻, amino acids, substituted or unsubstituted carboranes, perchlorates, pseudohalogens, metal chloride-based Lewis acids, C₁₋₆ carboxylates, and combinations thereof.

50. The method according to claim 49, wherein the cation is selected from the group consisting of imidazoles and pyridines, and the anion is selected from the group consisting of halogens, phosphates, alkylphosphates, alkenylphosphates, and bis(trifluoromethylsulfonyl)imide.

51. The method according to claim 44, wherein the lignocellulosic material is selected from the group consisting of tobacco, corn, corn stovers, corn residues, cornhusks, sugarcane bagasse, castor oil plant, rapeseed plant, soybean plant, cereal straw, grain processing by-products, bamboo, bamboo pulp, bamboo sawdust, energy grasses, wood, and combinations thereof.

52. The method according to claim 51, wherein the lignocellulosic material is a wood.

53. The method according to claim 44, wherein the lignocellulosic material, prior to dissolving in the ionic liquid, is in a form selected from the group consisting of ball-milled wood powder, sawdust, thermomechanical pulp fibers, wood chips, and combinations thereof.
